(19) United States
(12) Patent Application Publication
(10) Pub. No.: US 2026/0301684 A1
(43) Pub. Date: Oct. 1, 2026

(54) SCAN DRIVER, DISPLAY DEVICE INCLUDING SCAN DRIVER, AND ELECTRONIC DEVICE

(71) Applicant: Samsung Display Co., Ltd., Yongin-Si (KR)

(72) Inventors: Bo Yong CHUNG, Yongin-si (KR); Jong Hee KIM, Yongin-si (KR); Bo Gyeong KIM, Yongin-si (KR); Hyuk KIM, Yongin-si (KR); Byung Seok CHOI, Yongin-si (KR)

(21) Appl. No.: 19/416,361

(22) Filed: Dec. 11, 2025

(30) Foreign Application Priority Data
Mar. 27, 2025 (KR) 10-2025-0039852

(51) Int. Cl. G09G 3/3266; G09G 3/32

(52) U.S. Cl. CPC G09G 3/3266; G09G 3/32; G09G 2300/0842; G09G 2310/0286; G09G 2310/08; G09G 2330/021

(57) ABSTRACT

A display device includes a display panel including pixels connected to scan lines and initialization lines, and a scan driver including a plurality of stages configured to output scan signals to the scan lines and configured to output initialization signals to the initialization lines. A first stage among the plurality of stages includes a first control part, first output parts, a first carry output part, and a first reset part. The first reset part is connected between a first control node and a reset power terminal and is configured to electrically connect the first control node and the reset power terminal in response to a voltage of a second node. The first reset part electrically disconnects the first control node and the reset power terminal in response to a first carry clock signal.

### CROSS-REFERENCE TO RELATED APPLICATION

This application claims priority to and the benefit of Korean Patent Application No. 10-2025-0039852 filed in the Korean Intellectual Property Office on Mar. 27, 2025, the entire contents of which are incorporated herein by reference.

### BACKGROUND

### 1. Field

Embodiments of the present disclosure relates to a scan driver, a display device including the scan driver, and an electronic device.

### 2. Description of the Related Art

As information technology develops, the importance of display devices as a connection medium between users and information is increasing. In response, the use of display devices such as liquid crystal display devices, organic light-emitting display devices, and plasma display devices is increasing.

A display device includes a display panel including pixels, a scan driver for sequentially applying scan signals to scan lines connected to rows of pixels, and a data driver for applying data signals to data lines connected to columns of pixels. For example, the scan driver may select which of the pixels are to be supplied with a data voltage. The scan driver may be configured in the form of a shift register to sequentially provide scan signals of turn-on levels for each scan line.

The above description is intended solely to provide an understanding of the background technology for the technical ideas of the present disclosure, and is not to be construed as constituting prior art known to those skilled in the art of the present disclosure.

### SUMMARY

Embodiments of the present disclosure are intended to provide a scan driver with improved reliability, a display device including the scan driver, and an electronic device. For example, the scan driver may include a plurality of stages, and in each stage, a transistor may be added in a short path between a power terminal and a reset power terminal to improve unnecessary current losses. Thus, the scan driver, and the display device including the scan driver, may improve reliability with an improved circuit configuration.

A display device according to an embodiment of the present disclosure includes a display panel including pixels connected to scan lines and initialization lines; and a scan driver including a plurality of stages configured to output scan signals to the scan lines and configured to output initialization signals to the initialization lines. A first stage among the plurality of stages includes: a first control part connected to a first sub-node and configured to control a first control node, wherein a voltage of the first sub-node is controlled by a first node; first output parts connected to the first node and a second node and configured to output some of the scan signals in response to a voltage of the first control node; a first carry output part connected to the first node and the second node and configured to output a first carry clock signal to a first carry output terminal in response to a voltage of the first node; and a first reset part connected between the first control node and a reset power terminal and configured to electrically connect the first control node and the reset power terminal in response to a voltage of the second node. The first reset part electrically disconnects the first control node and the reset power terminal in response to the first carry clock signal.

The first reset part may include first reset transistors connected between the first control node and the reset power terminal, and having a gate electrode connected to the second node; and a second reset transistor connected between the first control node and the first reset transistors, and having a gate electrode connected to an input terminal of the first carry clock signal.

The first reset part may be connected to a first power terminal and a second power terminal, and may be configured to transmit a voltage of the first power terminal to the first control node in response to a first carry signal, and to transmit a voltage of the second power terminal to the first control node in response to a voltage of at least one of a second carry signal and the first sub-node. The first carry signal may be received from a second stage of the plurality of stages, and the second carry signal may be received from a third stage of the plurality of stages.

When the second carry signal has a first voltage level and a voltage of the second node has a second voltage level, the second reset transistor may disconnect an electrical connection between the first control node and the reset power terminal in response to the first carry clock signal.

When the first carry signal has a first voltage level and a voltage of the second node has a second voltage level, the second reset transistor may disconnect an electrical connection between the first control node and the reset power terminal in response to the first carry clock signal.

Voltages input to the first and second power terminals may be positive voltages, and a voltage input to the reset power terminal may be a negative voltage.

The first reset part may include first control transistors connected between the first power terminal and the first control node, and having a gate electrode connected to an input terminal for the first carry signal; a second control transistor connected between the second power terminal and the first control node, and having a gate electrode connected to the first sub-node; and a third control transistor connected between the second power terminal and the first control node, and having a gate electrode connected to an input terminal for the second carry signal.

One of the first output parts may include a first output transistor connected between an input terminal for one of scan clock signals and an output terminal for one of the scan signals, an having a gate electrode connected to a second sub-node, wherein a voltage of the second sub-node is controlled to a same voltage as the first sub-node; and a second output transistor connected between a third power terminal and the output terminal, and having a gate electrode connected to the second node.

The first carry output part may be configured to output a voltage of the third power terminal to the first carry output terminal in response to a voltage of the second node.

The first carry output part may include a first carry transistor connected between an input terminal for the first carry clock signal and the first carry output terminal, and having a gate electrode connected to the first node; and a second carry transistor connected between the third power terminal and the output terminal, and having a gate electrode connected to the second node.

The first stage may further include a boosting output part configured to transmit a boosting clock signal to the first sub-node in response to a voltage of the first node and to increase the voltage of the second sub-node according to the first sub-node.

The first stage may further include connecting parts configured to electrically connect the first node and the second sub-node in response to the voltage of the first control node.

One of the connecting parts may include a switching transistor connected between the first node and the second sub-node, and having a gate electrode connected to the first control node; and a boosting capacitor connected between the first sub-node and the second sub-node.

The plurality of stages may be configured to output the initialization signals. The first stage may include a second control part connected to a third sub-node and configured to control a second control node, wherein a voltage of the third sub-node is controlled by a third node; second output parts connected to the third node and a fourth node and configured to output some of the initialization signals in response to a voltage of the second control node; a second carry output part connected to the third node and the fourth node and configured to output a second carry clock signal to a second carry output terminal in response to a voltage of the third node; and a second reset part connected between the second control node and the reset power terminal and configured to electrically connect the second control node and the reset power terminal in response to a voltage of the fourth node. The second reset part may disconnect an electrical connection between the second control node and the reset power terminal in response to the second carry clock signal.

The second reset part may include third reset transistors connected between the second control node and the reset power terminal, and having a gate electrode connected to the fourth node; and a fourth reset transistor connected between the second control node and the third reset transistors, and having a gate electrode connected to an input terminal of the second carry clock signal.

The first stage may further include a driving part connected to the first control part and the second control part and configured to control voltages of the first to fourth nodes.

A scan driver according to an embodiment of the present disclosure includes a plurality of stages configured to output scan signals. A first stage among the plurality of stages includes a first control part connected to a first sub-node and configured to control a first control node, wherein a voltage of the first sub-node is controlled by a first node; first output parts connected to the first node and a second node and configured to output some of the scan signals in response to a voltage of the first control node; a first carry output part connected to the first node and the second node and configured to output a first carry clock signal to a first carry output terminal in response to a voltage of the first node; and a first reset part connected between the first control node and a reset power terminal and configured to electrically connect the first control node and the reset power terminal in response to a voltage of the second node. The first reset part electrically disconnects the first control node and the reset power terminal in response to the first carry clock signal.

The plurality of stages may be configured to output initialization signals. The first stage may includes a second control part connected to a third sub-node and configured to control a second control node, wherein a voltage of the third sub-node is controlled by a third node; second output parts connected to the third node and a fourth node and configured to output some of the initialization signals in response to a voltage of the second control node; a second carry output part connected to the third node and the fourth node and configured to output a second carry clock signal to a second carry output terminal in response to a voltage of the third node; and a second reset part connected between the second control node and the reset power terminal and configured to electrically connect the second control node and the reset power terminal in response to a voltage of the fourth node. The second reset part disconnects an electrical connection between the second control node and the reset power terminal in response to the second carry clock signal.

An electronic device according to an embodiment of the present disclosure includes one or more processors; and a display device including pixels and configured to display an image on the pixels under control of the processor. The display device includes: a display panel including the pixels connected to scan lines and initialization lines; and a scan driver including a plurality of stages configured to output scan signals to the scan lines and configured to output initialization signals to the initialization lines. A first stage among the plurality of stages includes: a first control part connected to a first sub-node and configured to control a first control node, wherein a voltage of the first sub-node is controlled by a first node; first output parts connected to the first node and a second node and configured to output some of the scan signals in response to a voltage of the first control node; a first carry output part connected to the first node and the second node and configured to output a first carry clock signal to a first carry output terminal in response to a voltage of the first node; and a first reset part connected between the first control node and a reset power terminal and configured to electrically connect the first control node and the reset power terminal in response to a voltage of the second node. The first reset part electrically disconnects the first control node and the reset power terminal in response to the first carry clock signal.

According to embodiments of the present disclosure, the scan driver with improved reliability, the display device including the scan driver, and the electronic device are provided.

The effects according to the embodiments are not limited to those described above, and more diverse effects are included in the present specification.

### BRIEF DESCRIPTION OF THE DRAWINGS

FIG. 1 is a block diagram illustrating an embodiment of a display device of the present disclosure.

FIG. 2 is a circuit diagram illustrating an embodiment of any one of the sub-pixels of FIG. 1.

FIG. 3 is a block diagram illustrating an embodiment of a scan driver included in the display device of FIG. 1.

FIG. 4 is a block diagram illustrating an embodiment of a stage included in the scan driver of FIG. 3.

FIG. 5 is a timing diagram illustrating an embodiment of an operation of the stage of FIG. 4.

FIGS. 6 and 7 are block diagrams illustrating an embodiment of an i-th stage circuit of FIG. 3.

FIG. 8 is a circuit diagram illustrating an embodiment of a driving part of FIG. 6.

FIG. 9 is a circuit diagram illustrating an embodiment of outputting scan signals of FIG. 6.

FIG. 10 is a timing diagram illustrating an embodiment of an operation of outputting the scan signals of FIG. 9.

FIG. 11 is a circuit diagram illustrating an embodiment of outputting initialization signals of FIG. 7.

FIG. 12 is a timing diagram illustrating an embodiment of an operation of outputting the initialization signals of FIG. 11.

FIG. 13 is a schematic block diagram illustrating an embodiment of an electronic device including a scan driver according to an embodiment of the present disclosure.

### DETAILED DESCRIPTION OF THE EMBODIMENTS

Hereinafter, preferred embodiments of the present disclosure will be described in detail with reference to the accompanying drawings. It should be understood that only those portions of the following description that are necessary to understand the operation according to the present disclosure will be described, and other portions will be omitted in order not to obscure the main points of the present disclosure. Furthermore, the present disclosure is not limited to the embodiments described herein and may be embodied in other forms. However, the embodiments described herein are provided to illustrate the technical ideas of the present disclosure in sufficient detail to facilitate the practice of the present disclosure by one having ordinary skill in the technical field to which the present disclosure belongs.

Throughout the specification, when a part is the to be “connected” to another part, this includes not only when it is “directly connected” but also when it is “indirectly connected” with another element in between. The terms used herein are intended to describe specific embodiments and are not intended to limit the present disclosure. Throughout the specification, when a part is the to “include” a component, it is meant to be inclusive of other components, not exclusive of other components, unless specifically noted to the contrary. “At least one of X, Y, and Z” and “at least one selected from the group consisting of X, Y, and Z” may be interpreted as one X, one Y, one Z, or any combination of two or more of X, Y, and Z (e.g., XYZ, XYY, YZ, ZX).

As used herein, terms such as first, second, and the like may be used to describe various components, but such components are not limited to such terms. These terms are used to distinguish one component from another. Thus, a first component may refer to a second component without departing from what is disclosed herein.

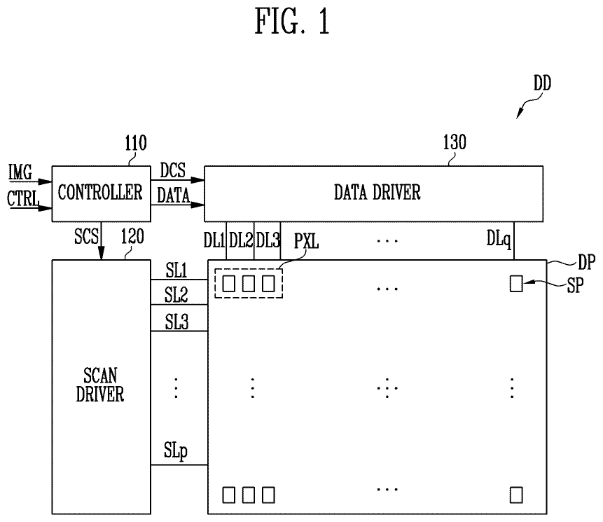

FIG. 1 is a block diagram illustrating an embodiment of a display device of the present disclosure.

Referring to FIG. 1, a display device DD may include a display panel DP, a controller 110, a scan driver 120, and a data driver 130.

The display panel DP may include sub-pixels SP. The sub-pixels SP may be connected to the scan driver 120 via first to p-th scan lines SL1 to SLp. The sub-pixels SP may be connected to the data driver 130 via first to q-th data lines DL1 to DLq.

The sub-pixels SP may generate light of two or more colors. For example, each of the sub-pixels SP may generate light such as red, green, blue, cyan, magenta, yellow, etc.

Two or more among the sub-pixels SP may constitute one pixel PXL. For example, the pixel PXL may include three sub-pixels as shown in FIG. 1. As such, the pixel PXL may emit light of various colors and various luminances depending on combination of light emitted from the sub-pixels included therein.

The controller 110 may control various operations of the display device DD. The controller 110 may receive input image data IMG and a corresponding control signal CTRL from an external source. The controller 110 may provide a scan control signal SCS, and a data control signal DCS in response to the control signal CTRL.

The controller 110 may convert the input image data IMG to be suitable for the display device DD or the display panel DP to output image data DATA. In embodiments, the controller 110 may output the image data DATA by arranging the input image data IMG to be suitable for the sub-pixels SP in a row unit.

The scan driver 120 may be connected to the sub-pixels SP arranged in a row direction via the first to p-th scan lines SL1 to SLp. The scan driver 120 may output scan signals to the first to p-th scan lines SL1 to SLp in response to the scan control signal SCS. In embodiments, the scan control signal SCS may include a start signal indicating the start of each frame, a horizontal synchronization signal, and the like.

The scan driver 120 may be located at one side of the display panel DP. However, embodiments are not limited thereto. For example, the scan driver 120 may be separated into two or more physically or logically distinct drivers, and such drivers may be located at one side of the display panel DP and on another side of the display panel DP opposite the one side. As such, the scan driver 120 may be located around the periphery of the display panel DP in various configurations according to embodiments.

The data driver 130 may be connected to the sub-pixels SP arranged in a column direction via the first to q-th data lines DL1 to DLq. The data driver 130 may receive the image data DATA and the data control signal DCS from the controller 110. The data driver 130 may operate in response to the data control signal DCS. In embodiments, the data control signal DCS may include a source start signal, a source shift clock, a source output enable signal, and the like.

The data driver 130 may apply data signals having grayscale voltages corresponding to the image data DATA to the first to q-th data lines DL1 to DLq. When a scan signal is applied to each of the first to p-th scan lines SL1 to SLp, data signals corresponding to the image data DATA may be applied to the data lines DL1 to DLq. Accordingly, the sub-pixels SP may generate light corresponding to the data signals, and the display panel DP may display the image.

In embodiments, the scan driver 120 and the data driver 130 may include complementary metal-oxide semiconductor (CMOS) circuit elements.

Components of the data driver 130 and the controller 110 may be mounted on a single integrated circuit. Although not shown in FIG. 1, the data driver 130 and the controller 110 may be included in a driver integrated circuit. In such cases, the data driver 130 and the controller 110 may be functionally distinct components within one driver integrated circuit.

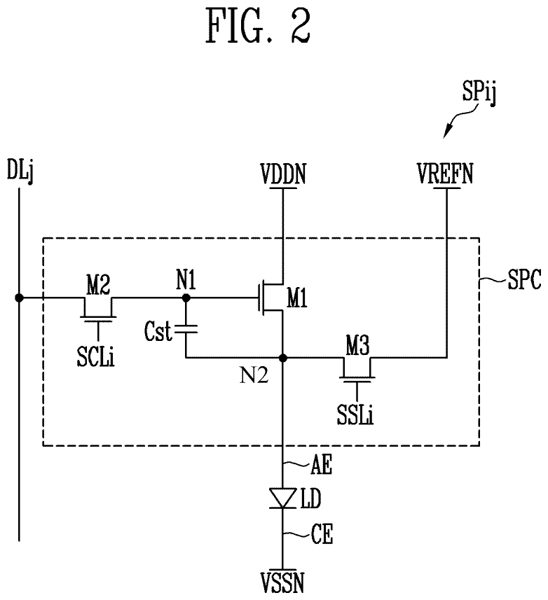

FIG. 2 is a circuit diagram illustrating an embodiment of any one of the sub-pixels of FIG. 1. In FIG. 2, among the sub-pixels SP of FIG. 1, a sub-pixel SPij arranged in an i-th row (where i is an integer greater than or equal to 1 and less than or equal to p) and a j-th column (where j is an integer greater than or equal to 1 and less than or equal to q) is illustrated as an example.

Referring to FIG. 2, the sub-pixel SPij may include a sub-pixel circuit SPC and a light-emitting element LD. The i-th scan line SLi may include an i-th scan line SCLi and an i-th initialization line SSLi.

A first electrode (or an anode electrode) AE of the light-emitting element LD may be connected to a first driving power node VDDN via a second node N2 and a first transistor M1, and a second electrode (or cathode electrode) CE may be connected to a second driving power node VSSN. The light-emitting element LD may generate light of a specific luminance in response to the amount of current supplied from the first transistor M1.

The first driving power node VDDN may be supplied with a first driving power, and the second driving power node VSSN may be supplied with a second driving power. During a period when the sub-pixel SPij emits light, the first driving power may have a higher voltage value compared to the second driving power.

The light-emitting element LD may be selected as an organic light-emitting diode. Further, the light-emitting element LD may be selected as an inorganic light-emitting diode, such as a micro-LED (light-emitting diode), a quantum dot light-emitting diode, etc. Further, the light-emitting element LD may also be an element composed of a combination of organic and inorganic material.

The sub-pixel circuit SPC may include a first transistor M1, a second transistor M2, a third transistor M3, and a storage capacitor Cst.

A first electrode of the first transistor M1 may be electrically connected to the first driving power node VDDN, and a second electrode may be electrically connected to the second node N2. A gate electrode of the first transistor M1 may be electrically connected to a first node N1. The first transistor M1 may control the amount of current supplied from the first driving power node VDDN to the second driving power node VSSN via the light-emitting element LD in response to a voltage of the first node N1.

The second transistor M2 may be electrically connected between the j-th data line DLj and the first node N1. A gate electrode of the second transistor M2 may be electrically connected to the i-th scan line SCLi. The second transistor M2 may be turned on when an enable scan signal is supplied to the i-th scan line SCLi to electrically connect the j-th data line DLj and the first node N1. When the second transistor M2 is turned on, a data signal from the j-th data line DLj may be supplied to the first node N1.

The scan signal may have a gate-on voltage (e.g., enable) or a gate-off voltage (e.g., disable). Hereinafter, an enable scan signal may mean that the gate-on voltage is supplied to the i-th scan line SCLi, and a disable scan signal may mean that the gate-off voltage is supplied to the i-th scan line SCLi.

The third transistor M3 may be electrically connected between the second node N2 and an initialization power node VREFN. And, a gate electrode of the third transistor M3 may be electrically connected to the i-th initialization line SSLi. The third transistor M3 may be turned on when an enable initialization signal is supplied to the i-th initialization line SSLi to electrically connect the second node N2 and the initialization power node VREFN. When the third transistor M3 is turned on, a voltage of a reference power from the initialization power node VREFN may be supplied to the second node N2.

The initialization power node VREFN may be supplied with a reference power. A voltage of the reference power may be set such that the light-emitting element LD is turned off when supplied to the second node N2. To this end, a voltage difference between the reference power and the second driving power may be less than a threshold voltage of the light-emitting element LD. For example, the voltage of the reference power may be set to the same or similar voltage as the second driving power.

The initialization signal may have a gate-on voltage (e.g., enable) or a gate-off voltage (e.g., disable). Hereinafter, an enable initialization signal may mean that the gate-on voltage is supplied to the i-th initialization line SSLi, and a disable initialization signal may mean that the gate-off voltage is supplied to the i-th initialization line SSLi.

While FIG. 2 illustrates the first transistor M1 to the third transistor M3 as N-type transistors, embodiments of the present disclosure are not limited thereto. For example, at least one transistor among the first transistor M1 to the third transistor M3 may be implemented as a P-type transistor.

The storage capacitor Cst may be connected between the first node N1 and the second node N2. The storage capacitor Cst may store a voltage corresponding to the data signal. For example, the storage capacitor Cst may store a voltage corresponding to a difference between the data signal supplied to the first node N1 and the reference power supplied to the second node N2.

Furthermore, in embodiments of the present disclosure, the structure of the sub-pixel SPij is not limited to the embodiment of FIG. 2. For example, the sub-pixel SPij may be implemented in various forms of circuitry currently known in the art.

Briefly describing an operation process, an enable scan signal and an enable initialization signal may be supplied sequentially to each of the scan lines SL1 to SLp during a driving period. The enable scan signal supplied to the i-th scan line SCLi may be supplied in synchronization with the enable initialization signal supplied to the i-th initialization line SSLi.

When the enable initialization signal is supplied to the i-th initialization line SSLi, the third transistor M3 may be turned on, and the voltage of the reference power may be supplied to the second node N2. When the enable scan signal is supplied to the i-th scan line SCLi, the second transistor M2 may be turned on, and the data signal may be supplied to the first node N1. In this case, the storage capacitor Cst may store a voltage corresponding to the difference between the data signal and the reference power.

Thereafter, the second transistor M2 may be turned off by a disable scan signal supplied to the i-th scan line SCLi, and the third transistor M3 may be turned off by a disable initialization signal supplied to the i-th initialization line SSLi. The first transistor M1 may supply a specific driving current to the light-emitting element LD in response to a voltage stored in the storage capacitor Cst, and the light-emitting element LD may generate light of a luminance corresponding to the driving current.

During a sensing period, an enable scan signal and an enable initialization signal synchronized to the enable scan signal may be supplied to at least one of the scan lines SL1 to SLp. A scan line (at least one of SL1 to SLp) to which the enable scan signal and the enable initialization signal are supplied during the sensing period may be set randomly for each sensing period.

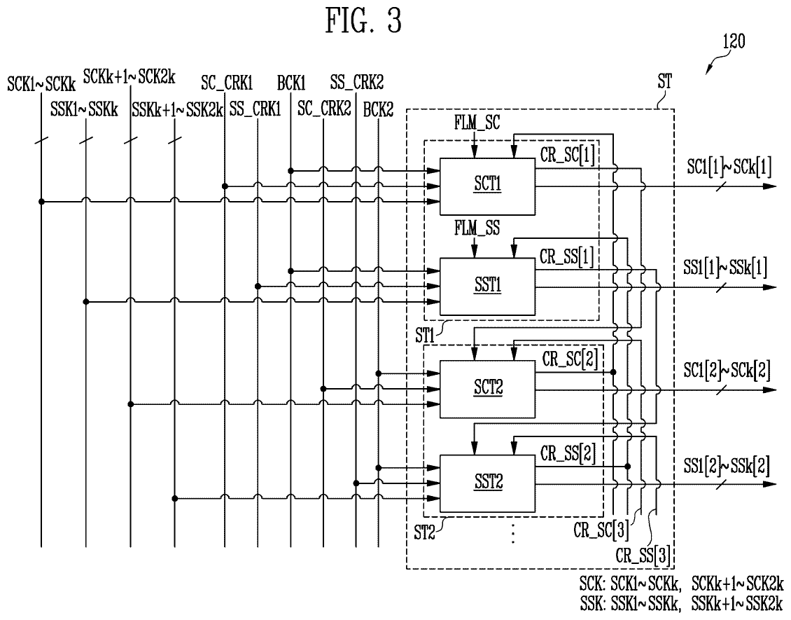

FIG. 3 is a block diagram illustrating an embodiment of a scan driver included in the display device of FIG. 1.

Referring to FIG. 3, the scan driver 120 may include a plurality of stages. For clarity and simplicity, only a first stage ST1 and a second stage ST2 among the plurality of stages are illustrated in FIG. 3, but other stages may operate similarly.

Referring to FIG. 3, the first and second stages ST1 and ST2 may be electrically connected to a plurality of scan lines and a plurality of initialization lines, respectively.

In embodiments, the first stage ST1 may include a first scan stage circuit SCT1 and a first initialization stage circuit SST1. The first scan stage circuit SCT1 of the first stage ST1 may be coupled with k scan lines and may supply scan signals SC1[1] to SCk[1] (where k is a natural number greater than or equal to 2) to the k scan lines. The first initialization stage circuit SST1 of the first stage ST1 may be connected to k initialization lines and may supply the initialization signals SS1[1] to SSk[1] to the k initialization lines.

The second stage ST2 may include a second scan stage circuit SCT2 and a second initialization stage circuit SST2. The second scan stage circuit SCT2 of the second stage ST2 may be coupled with k scan lines and may supply scan signals SC1[2] to SCk[2] to the k scan lines. The second initialization stage circuit SST2 of the second stage ST2 may be connected to k initialization lines and may supply the initialization signals SS1[2] to SSk[2] to the k initialization lines. As such, in embodiments of the present disclosure, a plurality of scan lines and a plurality of initialization lines may be driven using a single stage, and thus a mounting area of the scan driver 120 may be minimized or reduced.

The first and second stages ST1 and ST2 may receive scan clock signals SCK. For example, first to k-th scan clock signals SCK1 to SCKk may be provided to the first scan stage circuit SCT1 of the first stage ST1. The first to k-th scan clock signals SCK1 to SCKk supplied to the first scan stage circuit SCT1 of the first stage ST1 may be supplied to scan lines as first group scan signals SC1[1] to SCk[1].

(k+1)-th to 2k-th scan clock signals SCKk+1to SCK2k may be supplied to the second scan stage circuit SCT2 of the second stage ST2. The scan clock signals SCKk+1to SCK2k supplied to the second scan stage circuit SCT2 of the second stage ST2 may be supplied to scan lines as second group scan signals SC1[2] to SCk[2].

The first and second stages ST1 and ST2 may receive initialization clock signals SSK. First to the k-th initialization clock signals SSK1 to SSKk may be supplied to the first initialization stage circuit SST1 of the first stage ST1. The first to k-th initialization clock signals SSK1 to SSKk supplied to the first initialization stage circuit SST1 of the first stage ST1 may be supplied to initialization lines as first group initialization signals SS1[1] to SSk[1]. (k+1)-th to 2k-th initialization clock signals SSKk+1to SSK 2k may be supplied to the second initialization stage circuit SST2 of the second stage ST2. The (k+1)-th to 2k-th initialization clock signals SSKk+1to SSK2k supplied to the second initialization stage circuit SST2 of the second stage ST2 may be supplied to the initialization lines as second group initialization signals SS1[2] to SSk[2].

In embodiments, an odd-numbered stage may receive the first to k-th scan clock signals SCK1 to SCKk, and the first to k-th initialization clock signals SSK1 to SSKk. An even-numbered stage may receive the (k+1)-th to 2k-th scan clock signals SCKk+1 to SCK2k, and the (k+1)-th to 2k-th initialization clock signals SSKk+1 to SSK2k.

The scan clock signals and the initialization clock signals input to the odd-numbered stage may be different from the scan clock signals and the initialization clock signals input to the even-numbered stage. For example, the odd-numbered stage and the even-numbered stage may receive scan clock signals and initialization clock signals having a specific phase difference. However, embodiments are not limited thereto. For example, at least some of the scan clock signals and at least some of the initialization clock signals input to the odd-numbered stage and the even-numbered stage may be shared.

The first and second stages ST1 and ST2 may receive carry signals from a previous stage and a next stage. For example, the first scan stage circuit SCT1 of the first stage ST1 may receive a scan start signal FLM_SC (or a start pulse) as a scan carry signal from the previous stage. The first scan stage circuit SCT1 of the first stage ST1 may receive a second scan carry signal CR_SC[2] from the next stage. The first initialization stage circuit SST1 of the first stage ST1 may receive an initialization start signal FLM_SS (or a start pulse) as an initialization carry signal from the previous stage. The first initialization stage circuit SST1 of the first stage ST1 may receive a second initialization carry signal CR_SS[2] from the next stage.

The second scan stage circuit SCT2 of the second stage ST2 may receive a first scan carry signal CR_SC[1] from the previous stage. The second scan stage circuit SCT2 of the second stage ST2 may receive a third scan carry signal CR_SC[3] from the next stage. The second initialization stage circuit SST2 of the second stage ST2 may receive a first initialization carry signal CR_SS[1] from the previous stage. The second initialization stage circuit SST2 of the second stage ST2 may receive a third initialization carry signal CR_SS[3] from the next stage.

The first stage ST1 may receive a first scan carry clock signal SC_CRK1. The second stage ST2 may receive a second scan carry clock signal SC_CRK2. For example, the odd-numbered stage may receive the first scan carry clock signal SC_CRK1 and the even-numbered stage may receive the second scan carry clock signal SC_CRK2. The first and second scan carry clock signals SC_CRK1 and SC_CRK2 may have the same period and and may have different phases.

The first stage ST1 may receive the first initialization carry clock signal SS_CRK1. The second stage ST2 may receive the second initialization carry clock signal SS_CRK2. For example, the odd-numbered stage may receive the first initialization carry clock signal SS_CRK1 and the even-numbered stage may receive the second initialization carry clock signal SS_CRK2. The first and second initialization carry clock signals SS_CRK1 and SS_CRK2 may have the same period and may have different phases.

The first stage ST1 may receive a first boosting clock signal BCK1. The second stage ST2 may receive a second boosting clock signal BCK2. For example, the odd-numbered stage may receive the first boosting clock signal BCK1 and the even-numbered stage may receive the second boosting clock signal BCK2. The first and second boosting clock signals BCK1 and BCK2 may have the same period and may have different phases.

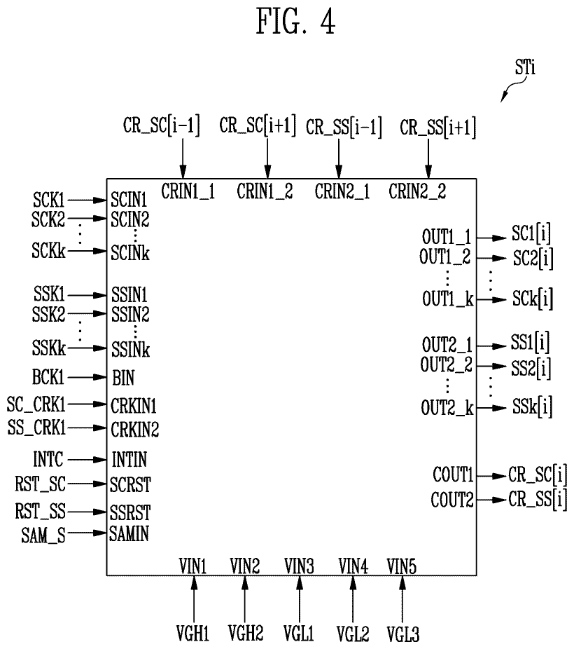

FIG. 4 is a block diagram illustrating an embodiment of a stage included in the scan driver of FIG. 3. For clarity and simplicity, FIG. 4 illustrates an i-th stage STi (where i is an odd number) as an example, but the remaining stages may operate similarly to the i-th stage STi.

Referring to FIGS. 3 and 4, the i-th stage STi may include first output terminals OUT1_1 to OUT1_k and second output terminals OUT2_1 to OUT2_k. Each of the first output terminals OUT1_1 to OUT1_k may be electrically connected to one of the scan lines. The first output terminals OUT1_1 to OUT1_k may supply i-th group scan signals SC1[i] to SCk[i] to the scan lines. Each of the second output terminals OUT2_1 to OUT2_k may be electrically connected to one of the initialization lines. The second output terminals OUT2_1 to OUT2_k may supply i-th group initialization signals SS1[i] to SSk[i] to the initialization lines.

The i-th stage STi has power input terminals VIN1, VIN2, VIN3, VIN4, and VIN5, scan clock input terminals SCIN1 to SCINk, initialization clock input terminals SSIN1 to SSINk, carry input terminals CRIN1_1, CRIN1_2, CRIN2_1, and CRIN2_2, a scan carry clock input terminal CRKIN1, an initialization carry clock input terminal CRKIN2, a boosting clock input terminal BIN, a scan reset input terminal SCRST, an initialization reset input terminal SSRST, a sampling input terminal SAMIN, an initialization terminal INTIN, and carry output terminals COUT1 and COUT2.

The first power input terminal VIN1 may receive a voltage of a first power VGH1. The first power VGH1 may have a positive voltage. The first power VGH1 may have a voltage level at which a transistor supplied with the first power VGH1 is turned on. For example, the first power VGH1 may have a voltage of 25V.

The second power input terminal VIN2 may receive a voltage of the second power VGH2. The second power VGH2 may have a positive voltage. The second power VGH2 may have a voltage level at which a transistor supplied with the second power VGH2 as a gate electrode is turned on or off based on a voltage of its first electrode (or second electrode). The second power VGH2 may have a lower voltage than the first power VGH1. For example, the second power VGH2 may have a voltage of 15V.

The third power input terminal VIN3 may receive a voltage of a third power VGL1. The third power VGL1 may have a negative voltage. The third power VGL1 may have a lower voltage than the second power VGH2. For example, the third power VGL1 may have a voltage of −9V.

The fourth power input terminal VIN4 may receive a voltage of a fourth power VGL2. The fourth power VGL2 may have a negative voltage. The fourth power VGL2 may have a lower voltage than the second power VGH2 and a higher voltage than the third power VGL1. For example, the fourth power VGL2 may have a voltage of-5V.

The fifth power input terminal VIN5 may receive a voltage of a fifth power VGL3. The fifth power VGL3 may have a negative voltage. The fifth power VGL3 may be set to a variety of voltages. For example, the fifth power VGL3 may be set to the same voltage as the fourth power VGL2.

Each of the scan clock input terminals SCIN1 to SCINk may receive any one of the scan clock signals SCK1 to SCKk. The scan clock signals SCK1 to SCKk may be output to any one of the first output terminals OUT1_1 to OUT1_k.

Each of the initialization clock input terminals SSIN1 to SSINk may receive any one of the initialization clock signals SSK1 to SSKk. The initialization clock signals SSK1 to SSKk may be output to any one of the second output terminals OUT2_1 to OUT2_k.

The carry input terminals CRIN1_1, CRIN1_2, and CRIN2_1, and CRIN2_2 may receive carry signals from the previous stage and the next stage. For example, the first scan carry input terminal CRIN1_1 and the second scan carry input terminal CRIN1_2 may receive an (i−1)-th scan carry signal CR_SC[i−1] from the previous stage and an (i+1)-th scan carry signal CR_SC[i+1] from the next stage. The first initialization carry input terminal CRIN2_1 and the second initialization carry input terminal CRIN2_2 may receive an (i−1)-th initialization carry signal CR_SS[i−1] from the previous stage and an (i+1)-th initialization carry signal CR_SS[i+1] from the next stage.

The scan carry clock input terminal CRKIN1 may receive the first scan carry clock signal SC_CRK1. The initialization carry clock input terminal CRKIN2 may receive a first initialization carry clock signal SS_CRK1. However, embodiments are not limited thereto. For example, depending on the stage, the scan carry clock input terminal CRKIN1 may receive the second scan carry clock signal SC_CRK2. The initialization carry clock input terminal CRKIN2 may receive the second initialization carry clock signal SS_CRK2.

The boosting clock input terminal BIN may receive a first boosting clock signal BCK1. However, embodiments are not limited thereto. For example, depending on the stage, the boosting clock input terminal BIN may receive a second boosting clock signal BCK2.

The scan reset input terminal SCRST may receive a scan reset signal RST_SC. The scan reset signal RST_SC may be supplied common to the stages, and may be used to reset a scan stage circuit included in the stages for generating a scan signal.

The initialization reset input terminal SSRST may receive an initialization reset signal RST_SS. The initialization reset signal RST_SS may be common to the stages, and may be used to reset an initialization stage circuit included in the stages for generating an initialization signal.

The sampling input terminal SAMIN may receive a sampling signal SAM_S. The sampling signal SAM_S is supplied during a driving period and may be a signal for selecting a stage (or, a scan line and an initialization line) to be supplied with a scan signal and an initialization signal during a sensing period.

The initialization terminal INTIN may receive an initialization control signal INTC. The initialization control signal INTC is supplied during the sensing period, and may be a signal that enables the scan signal and the initialization signal to be supplied in the stage selected by the sampling signal SAM_S. That is, the scan reset signal RST_SC, the initialization reset signal RST_SS, the sampling signal SAM_S, and the initialization control signal INTC may be signals commonly supplied to the stages ST.

The first carry output terminal COUT1 may output a scan carry signal. The first carry output terminal COUT1 included in the i-th stage STi may output an i-th scan carry signal CR_SC[i].

The second carry output terminal COUT2 may output an initialization carry signal. The second carry output terminal COUT2 included in the i-th stage STi may output an i-th initialization carry signal CR_SS[i].

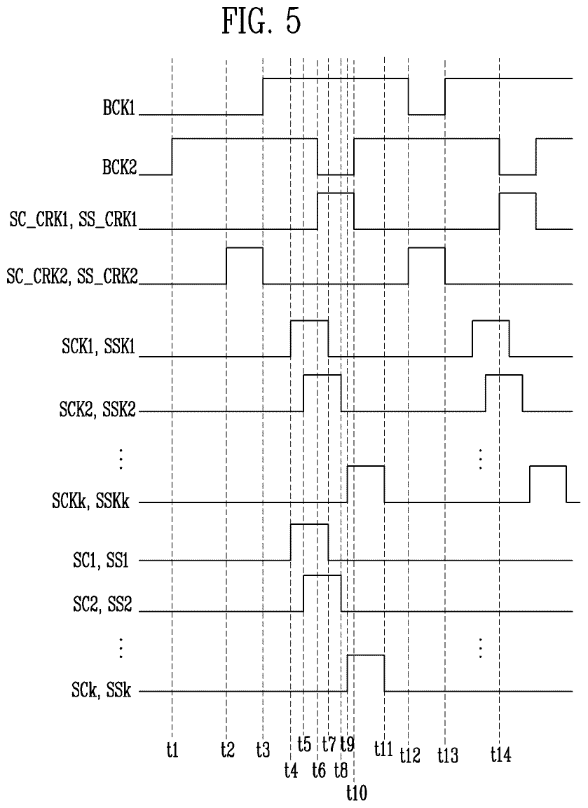

FIG. 5 is a timing diagram illustrating an embodiment of an operation of the stage of FIG. 4.

Referring to FIGS. 4 and 5, first and second boosting clock signals BCK1 and BCK2, first and second scan carry clock signals SC_CRK1 and SC_CRK2, first and second initialization carry clock signals SS_CRK1 and SS_CRK2, scan clock signals SCK1 to SCKk, and scan signals SC1 to SCk are shown.

The first and second boosting clock signals BCK1 and BCK2 may be input to the boosting clock input terminal BIN. For example, the first boosting clock signal BCK1 may be input to an odd-numbered stage and the second boosting clock signal BCK2 may be input to an even-numbered stage.

The first and second boosting clock signals BCK1 and BCK2 have the same period and may be in different phases. For example, at a first time point t1, the second boosting clock signal BCK2 may transition from a logic low-level voltage (hereinafter referred to as a low-level voltage) to a logic high-level voltage (hereinafter referred to as a high-level voltage). At a sixth time point t6, the second boosting clock signal BCK2 may transition from the high-level voltage to the low-level voltage. At a tenth time point t10, the second boosting clock signal BCK2 may transition from a low-level voltage to a high-level voltage. At a fourteenth time point t14, the second boosting clock signal BCK2 may transition from a high-level voltage to a low-level voltage. On the other hand, at a third time point t3, the first boosting clock signal BCK1 may transition from a low-level voltage to a high-level voltage. At a twelfth time point t12, the first boosting clock signal BCK1 may transition from a high-level voltage to a low-level voltage. At a thirteenth time point t13, the first boosting clock signal BCK1 may transition from a low-level voltage to a high-level voltage.

The first and second scan carry clock signals SC_CRK1 and SC_CRK2 may be input to the scan carry clock input terminal CRKIN1. For example, the first scan carry clock signal SC_CRK1 may be input to an odd-numbered stage, and the second scan carry clock signal SC_CRK2 may be input to an even-numbered stage.

The first and second scan carry clock signals SC_CRK1 and SC_CRK2 have the same period and may be in different phases. For example, at a second time point t2, the second scan carry clock signal SC_CRK2 may transition from a low-level voltage to a high-level voltage. At a third time point t3, the second scan carry clock signal SC_CRK2 may transition from a high-level voltage to a low-level voltage.

The second scan carry clock signal SC_CRK2 may be a signal that is in phase with the first boosting clock signal BCK1. The interval during which the second scan carry clock signal SC_CRK2 has a high-level voltage may overlap with some of the intervals during which the second boosting clock signal BCK2 has a high-level voltage.

For example, at a sixth time point t6, the first scan carry clock signal SC_CRK1 may transition from a low-level voltage to a high-level voltage. At a tenth time point t10, the first scan carry clock signal SC_CRK1 may transition from a high-level voltage to a low-level voltage.

The first scan carry clock signal SC_CRK1 may be a signal that is in phase with the second boosting clock signal BCK2. The interval during which the first scan carry clock signal SC_CRK1 has a high-level voltage may overlap with some of the intervals during which the first boosting clock signal BCK1 has a high-level voltage.

The first and second scan carry clock signals SC_CRK1 and SC_CRK2 may have the same period as the first and second boosting clock signals BCK1 and BCK2. During one cycle, the high-level voltages of the first and second scan carry clock signals SC_CRK1 and SC_CRK2 may be supplied for a shorter time than the low-level voltages. During one cycle, the low-level voltages of the first and second boosting clock signals BCK1 and BCK2 may be supplied for a shorter time than the high-level voltages.

The first and second initialization carry clock signals SS_CRK1 and SS_CRK2 may be input to the initialization carry clock input terminal CRKIN2. For example, the first initialization carry clock signal SS_CRK1 may be input to an odd-numbered stage and the second initialization carry clock signal SS_CRK2 may be input to an even-numbered stage.

The first and second initialization carry clock signals SS_CRK1 and SS_CRK2 have the same period and and may have different phases. The first initialization carry clock signal SS_CRK1 may be a signal synchronized with the first scan carry clock signal SC_CRK1. The second initialization carry clock signal SS_CRK2 may be a signal synchronized with the second scan carry clock signal SC_CRK2.

The first to k-th scan clock signals SCK1 to SCKk may be pulses having low-level and high-level voltages. Each of the first to k-th scan clock signals SCK1 to SCKk may have a phase that is delayed from a previous scan clock signal, but may partially overlap with the previous scan clock signal. For example, the second scan clock signal SCK2 may have a phase delay from the first scan clock signal SCK1. The high-level voltages of the second scan clock signal SCK2 may be phase-lagged from the high-level voltages of the first scan clock signal SCK1, but may partially overlap in time. For example, at the fourth time point t4, the first scan clock signal SCK1 may transition from a low-level voltage to a high-level voltage. At a fifth time point t5 after the fourth time point t4, the second scan clock signal SCK2 may transition from a low-level voltage to a high-level voltage. At a seventh time point t7, the first scan clock signal SCK1 may transition from a high-level voltage to a low-level voltage. At an eighth time point t8 after the seventh time point t7, the second scan clock signal SCK2 may transition from a high-level voltage to a low-level voltage.

The high-level voltages of the k-th scan clock signal SCKk may be phase-lagged from the high-level voltages of the (k−1)-th scan clock signal, but may temporally overlap. For example, at a ninth time point t9, the k-th scan clock signal SCKk may transition from a low-level voltage to a high-level voltage. At time eleventh time point t11, the k-th scan clock signal SCKk may transition from a high-level voltage to a low-level voltage.

The first to k-th initialization clock signals SSK1 to SSKk may be signals that are synchronized with the first to k-th scan clock signals SCK1 to SCKk. For example, the first initialization clock signal SSK1 may have the same period and phase as the first scan clock signal SCK1. The second initialization clock signal SSK2 may have the same period and phase as the second scan clock signal SCK2. The k-th initialization clock signal SSKk may have the same period and phase as the k-th scan clock signal SCKk.

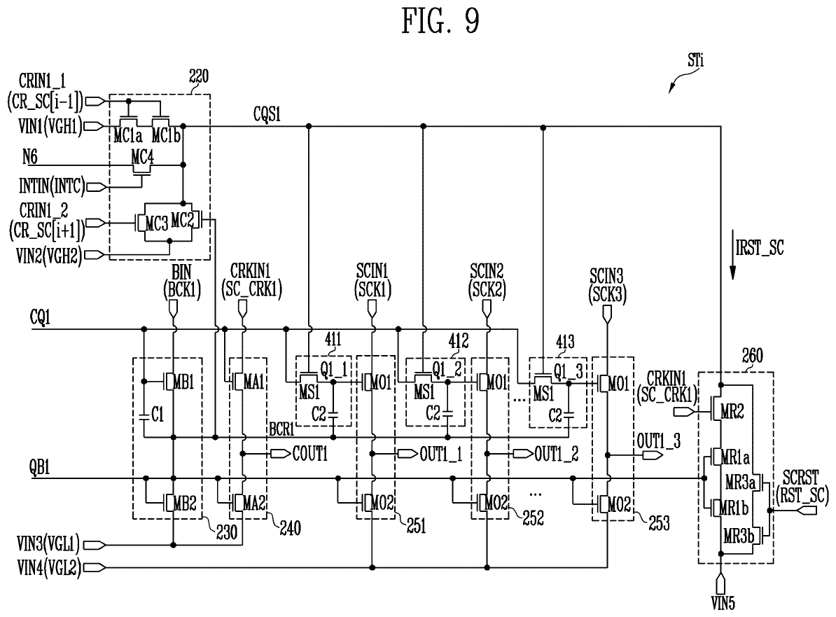

The first to k-th scan clock signals SCK1 to SCKk may be output as scan signals SC1 to SCk via a first output transistor MO1 (see FIG. 9). For example, a first scan signal SC1 may have the same period and phase as the first scan clock signal SCK1. A second scan signal SC2 may have the same period and phase as the second scan clock signal SCK2. A k-th scan signal SCk may have the same period and phase as the k-th scan clock signal SCKk. Accordingly, each of the scan signals SC1 to SCk may have a phase that is delayed from a previous scan signal, but may partially overlap with the previous scan signal, according to the first to k-th scan clock signals SCK1 to SCKk.

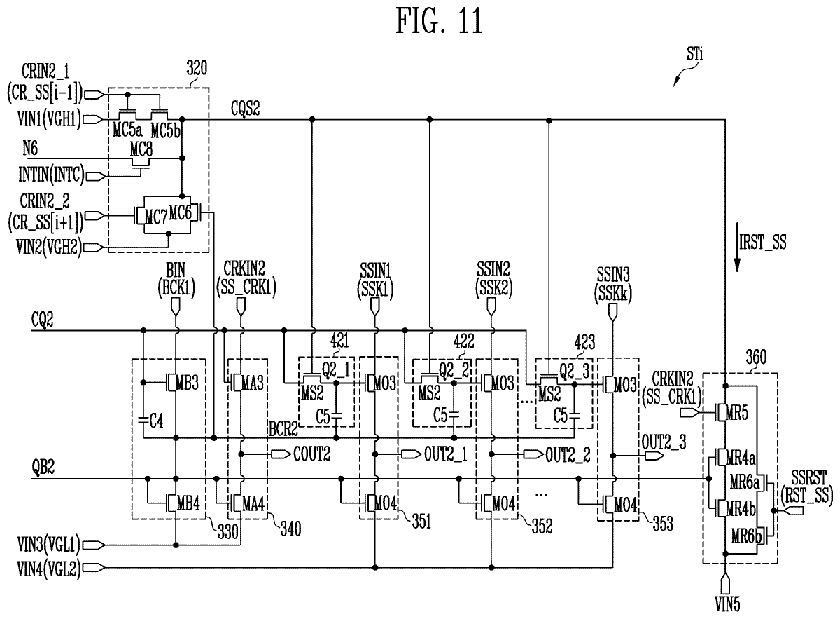

The first to k-th initialization clock signals SSK1 to SSKk may be output as initialization signals SS1 to SSk via a third output transistor MO3 (see FIG. 11). For example, a first initialization signal SS1 may have the same period and phase as the first initialization clock signal SCK1. A second initialization signal SS2 may have the same period and phase as the second initialization clock signal SCK2. A k-th initialization signal SSk may have the same period and phase as the k-th initialization clock signal SCKk. Thus, according to the first to k-th initialization clock signals SSK1 to SSKk, each of the initialization signals SS1 to SSk may have a phase that is delayed from a previous initialization signal, but may partially overlap with the previous initialization signal.

However, while some of the first to k-th scan clock signals SCK1 to SCKk are described as overlapping, embodiments are not limited thereto. For example, the first to k-th scan clock signals SCK1 to SCKk may not ovelap with each other. Accordingly, the first to k-th initialization clock signals SSK1 to SSKk synchronized with the first to k-th scan clock signals SCK1 to SCKk may also not overlap with each other.

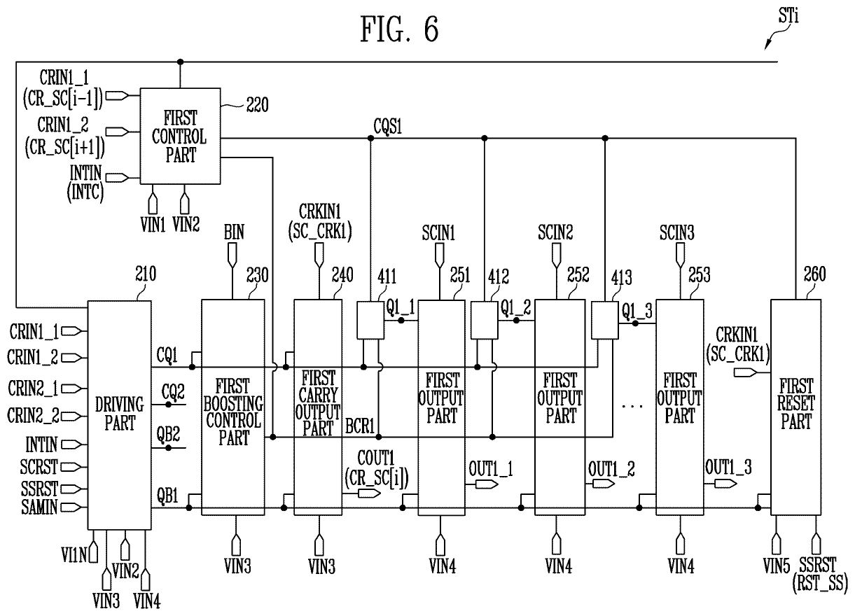

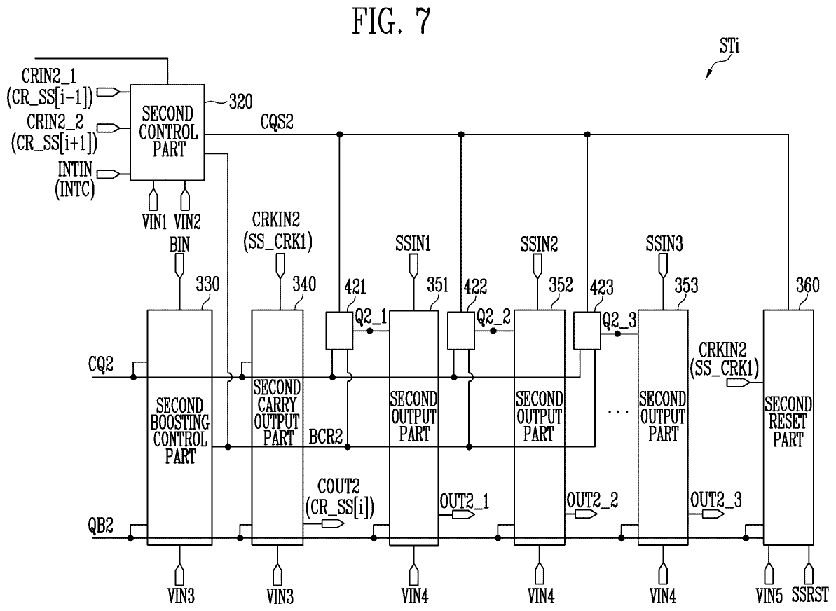

FIGS. 6 and 7 are block diagrams illustrating an embodiment of an i-th stage of FIG. 4.

Referring to FIGS. 6 and 7, the i-th stage STi includes a driving part 210, a first control part 220, a first boosting control part 230, a first carry output part 240, first output parts 251, 252, and 253, first connecting parts 411, 412, and 413, a first reset part 260, a second control part 320, a second boosting control part 330, a second carry output part 340, second output parts 351, 352, and 353, second connecting parts 421, 422, and 423, and a second reset part 360.

The driving part 210 includes a first power input terminal VIN1, a second power input terminal VIN2, a third power input terminal VIN3, a fourth power input terminal VIN4, a first scan carry input terminal CRIN1_1, a second scan carry input terminal CRIN1_2, a first initialization carry input terminal CRIN2_1, a second initialization carry input terminal CRIN2_2, a scan reset input terminal SCRST, an initialization reset input terminal SSRST, a sampling input terminal SAMIN, and an initialization terminal INTIN.

The driving part 210 may control voltages of a first node CQ1, a second node QB1, a third node CQ2, and a fourth node QB2. The first node CQ1 and the second node QB1 may be nodes for controlling the first boosting control part 230, the first carry output part 240, the first output parts 251, 252, and 253, the first connecting parts 411, 412, and 413, and the first reset part 260. The first boosting control part 230, the first carry output part 240, the first output parts 251, 252, and 253, the first connecting parts 411, 412, and 413, and the first reset part 260 controlled by the voltages of the first node CQ1 and the second node QB1 may be included in one of the scan stage circuits SCT1 and SCT2 of FIG. 3.

The third node CQ2 and the fourth node QB2 may be nodes for controlling the second boosting control part 330, the second carry output part 340, the second output parts 351, 352, and 353, the second connecting parts 421, 422, and 423, and the second reset part 360. The second boosting control part 330, the second carry output part 340, the second output parts 351, 352, and 353, the second connecting parts 421, 422, and 423, and the second reset part 360 controlled by the voltages of the third node CQ2 and the fourth node QB2 may be included in one of the initialization stage circuits SST1 and SST2 of FIG. 3.

The first control part 220 may be connected to the first connecting parts 411, 412, and 413 via the first control node CQS1. The first control part 220 may be connected to the first scan carry input terminal CRIN1_1, the second scan carry input terminal CRIN1_2, the initialization terminal INTIN, the first power input terminal VIN1, and the second power input terminal VIN2. The first control part 220 may control a voltage of the first control node CQS1 based on scan carry signals CR_SC[i−1] and CR_SC[i+1] input to the first and second scan carry input terminals CRIN1_1 and CRIN1_2. Further, the first control part 220 may control the voltage of the first control node CQS1 based on an initialization control signal INTC input to the initialization terminal INTIN.

The first boosting control part 230 may be connected to the boosting clock input terminal BIN, the third power input terminal VIN3, and a first sub-node BCR1. The first boosting control part 230 may output a first boosting clock signal to the first sub-node BCR1 in response to voltages of the first node CQ1 and the second node QB1. The first sub-node BCR1 may be electrically connected to the first connecting parts 411, 412, and 413.

The first carry output part 240 may be connected to the scan carry clock input terminal CRKIN1, the third power input terminal VIN3, and the first carry output terminal COUT1. The first carry output part 240 may output an i-th scan carry signal CR_SC[i] to the first carry output terminal COUT1 in response to voltages of the first node CQ1 and the second node QB1.

Each of the first output parts 251, 252, and 253 may be connected to any one of the scan clock input terminals SCIN1 to SCIN3, any one of the first output terminals OUT1_1 to OUT1_3, and the fourth power input terminal VIN4. Each of the first output parts 251, 252, and 253 may be connected to the first node CQ1 via any one of second sub-nodes Q1_1, Q1_2, and Q1_3 and any one of the first connecting parts 411, 412, and 413. The first output parts 251, 252, and 253 may supply scan signals to the first output terminals OUT1_1 to OUT1_3 based on voltages of the second sub-nodes Q1_1, Q1_2, and Q1_3 (or the first node CQ1). However, while FIG. 6 shows each of the first output parts 251, 252, and 253, the first connecting parts 411, 412, and 413, the second sub-nodes Q1_1, Q1_2, and Q1_3, and the first output terminals OUT1_1 to OUT1_3 as three for clarity and simplicity, embodiments are not limited thereto. For example, each of the first outputs, the first connecting parts, the second sub-nodes, and the first output terminals may be implemented with six.

The first connecting parts 411, 412, and 413 may be connected between the first node CQ1 and the second sub-nodes Q1_1, Q1_2, and Q1_3. The first connecting parts 411, 412, and 413 may electrically connect or disconnect the first node CQ1 and the second sub-nodes Q1_1, Q1_2, and Q1_3 in response to the first control node CQS1.

For example, the first connecting parts 411, 412, and 413 may control electrical connections between the first node CQ1 and the second sub-nodes Q1_1, Q1_2, and Q1_3 in response to a voltage of the first control node CQS1. For example, the first connecting parts 411, 412, and 413 may electrically connect the first node CQ1 and the second sub-nodes Q1_1, Q1_2, and Q1_3 when the first control node CQS1 has a high-level voltage. The first connecting parts 411, 412, and 413 may electrically disconnect the first node CQ1 and the second sub-nodes Q1_1, Q1_2, and Q1_3 when the first control node CQS1 has a low-level voltage.

The first reset part 260 may be connected to the first control node CQS1 and the fifth power input terminal VIN5. The first reset part 260 may control an electrical connection between the first control node CQS1 and the fifth power input terminal VIN5 based on a voltage of the second node QB1. For example, the first reset part 260 may supply a voltage of the fifth power VGL3 (or a logic low-level voltage) to the first control node CQS1 based on the voltage of the second node QB1.

The first reset part 260 may be connected to the scan carry clock input terminal CRKIN1. The first reset part 260 may disconnect the electrical connection between the first control node CQS1 and the fifth power input terminal VIN5 in response to the first scan carry clock signal SC_CRK1. The first reset part 260 may block a short path formed between the first control node CQS1 and the fifth power input terminal VIN5 based on the first scan carry clock signal SC_CRK1. For example, when the scan carry signals CR_SC[i−1] and CR_SC[i+1] have a high-level voltage and a voltage of the second node QB1 has a high-level voltage, the first reset part 260 may disconnect the electrical connection between the first control node CQS1 and the fifth power input terminal VIN5 in response to the first scan carry clock signal SC_CRK1. In this way, the first reset part 260 may cut off a short path formed between the first control node CQS1 and the fifth power input terminal VIN5, thereby improving unnecessary current losses.

The second control part 320 may be connected to the second connecting parts 421, 422, and 423 via a second control node CQS2. The second control part 320 may be connected to the first initialization carry input terminal CRIN2_1, the second initialization carry input terminal CRIN2_2, the initialization terminal INTIN, the first power input terminal VIN1, and the second power input terminal VIN2. The second control part 320 may control a voltage of the second control node CQS2 based on initialization carry signals CR_SS[i−1] and CR_SS[i+1] input to the first and second initialization carry input terminals CRIN2_1 and CRIN2_2. Further, the second control part 320 may control the voltage of the second control node CQS2 based on an initialization control signal INTC input to the initialization terminal INTIN.

The second boosting control part 330 may be connected to the boosting clock input terminal BIN, the third power input terminal VIN3, and a third sub-node BCR2. The second boosting control part 330 may output a second boosting clock signal to the third sub-node BCR2 in response to voltages of the third node CQ2 and the fourth node QB2. The third sub-node BCR2 may be electrically connected to the second connecting parts 421, 422, and 423.

The second carry output part 340 may be connected to the initialization carry clock input terminal CRKIN2, the third power input terminal VIN3, and the second carry output terminal COUT2. The second carry output part 340 may output an i-th initialization carry signal CR_SS[i] to the second carry output terminal COUT2 in response to the voltages of the third node CQ2 and the fourth node QB2.

Each of the second output parts 351, 352, and 353 may be connected to any one of the initialization clock input terminals SSIN1 to SSIN3, any one of the second output terminals OUT2_1 to OUT2_3, and the fourth power input terminal VIN4. Each of the second output parts 351, 352, and 353 may be connected to the third node CQ2 via any one of fourth sub-nodes Q2_1, Q2_2, and Q2_3, and any one of the second connecting parts 421, 422, and 423. The second output parts 351, 352, and 353 may supply initialization signals to the second output terminals OUT2_1 to OUT2_3 based on voltages of the fourth sub-nodes Q2_1, Q2_2, and Q2_3 (or the third node CQ2). However, while FIG. 7 illustrates each of the second output parts 351, 352, and 353, the second connecting parts 421, 422, and 423, the fourth sub-nodes Q2_1, Q2_2, and Q2_3, and the second output terminals OUT2_1 to OUT2_3 as three for clarity and simplicity, embodiments are not limited thereto. For example, each of the second outputs, the second connecting parts, the fourth sub-nodes, and the second output terminals may be implemented with six.

The second connecting parts 421, 422, and 423 may be connected between the third node CQ2 and fourth sub-nodes Q2_1, Q2_2, and Q2_3. The second connecting parts 421, 422, and 423 may electrically connect or disconnect the third node CQ2 and the fourth sub-nodes Q2_1, Q2_2, and Q2_3 in response to the second control node CQS2.

For example, the second connecting parts 421, 422, and 423 may control electrical connections between the third node CQ2 and the fourth sub-nodes Q2_1, Q2_2, and Q2_3 in response to a voltage of the second control node CQS2. For example, the second connecting parts 421, 422, and 423 may electrically connect the third node CQ2 and the fourth sub-nodes Q2_1, Q2_2, and Q2_3 when the second control node CQS2 has a high-level voltage. The second connecting parts 421, 422, and 423 may electrically disconnect the third node CQ2 and the fourth sub-nodes Q2_1, Q2_2, and Q2_3 when the second control node CQS2 has a low-level voltage.

The second reset part 360 may be connected to the second control node CQS2 and the fifth power input terminal VIN5. The second reset part 360 may control an electrical connection between the second control node CQS2 and the fifth power input terminal VIN5 based on a voltage of the fourth node QB2. For example, the second reset part 360 may supply a voltage of the fifth power VGL3 (or a logic low-level voltage) to the second control node CQS2 based on the voltage of the fourth node QB2.

The second reset part 360 may be connected to the initialization carry clock input terminal CRKIN2. The second reset part 360 may disconnect the electrical connection between the second control node CQS2 and the fifth power input terminal VIN5 in response to the first initialization carry clock signal SS_CRK1. For example, the second reset part 360 may block a short path formed between the second control node CQS2 and the fifth power input terminal VIN5 based on the first initialization carry clock signal SS_CRK1. For example, when the initialization carry signals CR_SS[i−1] and CR_SS[i+1] have a high-level voltage and the voltage of the fourth node QB2 has a high-level voltage, the second reset part 360 may disconnect the electrical connection between the second control node CQS2 and the fifth power input terminal VIN5 in response to the first initialization carry clock signal SS_CRK1. In this way, the second reset part 360 may cut off a short path formed between the second control node CQS2 and the fifth power input terminal VIN5, thereby improving unnecessary current losses.

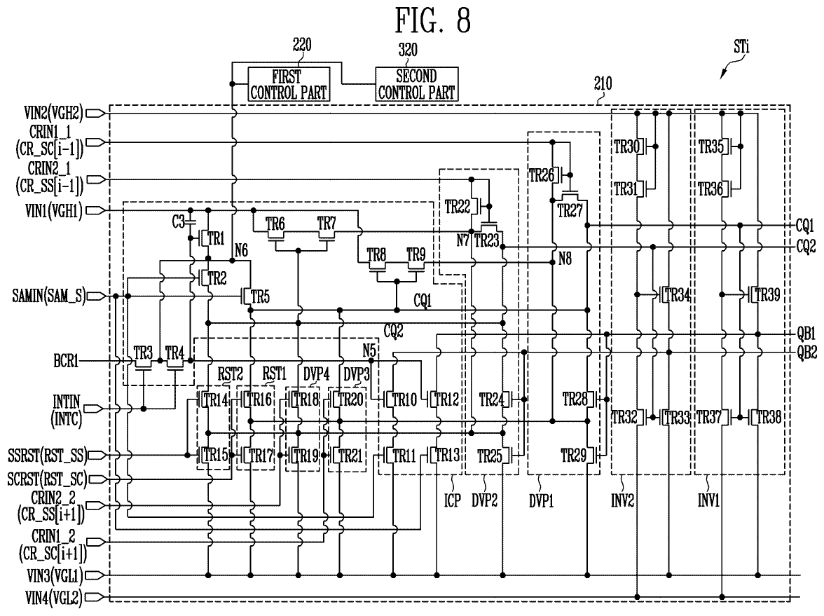

FIG. 8 is a circuit diagram illustrating an embodiment of a driving part of FIG. 6.

Referring to FIG. 8, the i-th stage STi may include a driving part 210. The driving part 210 may include an initialization control part ICP, a first reset control part RST1, a second reset control part RST2, a first driving part DVP1, a second driving part DVP2, a third driving part DVP3, a fourth driving part DVP4, a first inverter part INV1, and a second inverter part INV2.

The first inverter part INV1 may control a voltage of the second node QB1 in response to a voltage of the f irst node CQ1. For example, the first inverter part INV1 may set the voltage of the second node QB1 to a low-level voltage (or a high-level voltage) when the voltage of the first node CQ1 is a high-level voltage (or a low-level voltage). The first inverter part INV1 may include 35th to 39th transistors TR35 to TR39.

The 35th and 36th transistors TR35 and TR36 may be connected in series between the second power input terminal VIN2 and a gate electrode of the 39th transistor TR39. Gate electrodes of the 35th and 36th transistors TR35 and TR36 may be connected to the second power input terminal VIN2. The 35th and 36th transistors TR35 and TR36 may be diode-connected to allow current to flow from the second power input terminal VIN2 to the gate electrode of the 39th transistor TR39.

The 37th transistor TR37 may be connected between the gate electrode of the 39th transistor TR39 and the fourth power input terminal VIN4. A gate electrode of the 37th transistor TR37 may be connected to the first node CQ1.

The 38th transistor TR38 may be connected between the second node QB1 and the third power input terminal VIN3. A gate electrode of the 38th transistor TR38 may be connected to the first node CQ1.

The 39th transistor TR39 may be connected between the second power input terminal VIN2 and the second node QB1. A gate electrode of the 39th transistor TR39 may be connected to a common node between the 36th transistor TR36 and the 37th transistor TR37.

The second inverter part INV2 may control a voltage of the fourth node QB2 in response to a voltage of the third node CQ2. For example, the second inverter part INV2 may set the voltage of the fourth node QB2 to a low-level voltage (or a high-level voltage) when the voltage of the third node CQ2 is a high-level voltage (or a low-level voltage). The second inverter part INV2 may include 30th to 34th transistors TR30 to TR34.

The 30th and 31st transistors TR30 and TR31 may be connected in series between the second power input terminal VIN2 and a gate electrode of the 34th transistor TR34. Gate electrodes of the 30th and 31st transistors TR30 and TR31 may be connected to the second power input terminal VIN2. The 30th and 31st transistors TR30 and TR31 may be diode-connected to allow current to flow from the second power input terminal VIN2 to the gate electrodes of the 34th transistor TR34.

The 32nd transistor TR32 may be connected between the gate electrode of the 34th transistor TR34 and the fourth power input terminal VIN4. A gate electrode of the 32nd transistor TR32 may be connected to the third node CQ2.

The third transistor TR33 may be connected between the fourth node QB2 and the third power input terminal VIN3. A gate electrode of the third transistor TR33 may be connected to the third node CQ2.

The 34th transistor TR34 may be connected between the second power input terminal VIN2 and the fourth node QB2. A gate electrode of the 34th transistor TR34 may be connected to a common node between the 31st transistor TR31 and the 32nd transistor TR32.

The first driving part DVP1 may supply a high-level voltage to the first node CQ1 when the (i−1)-th scan carry signal CR_SC[i−1] is input from the first scan carry input terminal CRIN1_1. The first driving part DVP1 may include the 26th to 29th transistors TR26 to TR29.

The 26th transistor TR26 may be connected between the first scan carry input terminal CRIN1_1 and an eighth node N8. A gate electrode of the 26th transistor TR26 may be connected to the first scan carry input terminal CRIN1_1. The 26th transistor TR26 may be diode-connected to allow current to flow from the first scan carry input terminal CRIN1_1 to the eighth node N8.

The 27th transistor TR27 may be connected between the eighth node N8 and the first node CQ1. A gate electrode of the 27th transistor TR27 may be connected to the first scan carry input terminal CRIN1_1.

The 28th transistor TR28 may be connected between the first node CQ1 and the eighth node N8. A gate electrode of the 28th transistor TR28 may be connected to the second node QB1.

The 29th transistor TR29 may be connected between the eighth node N8 and the third power input terminal VIN3. A gate electrode of the 29th transistor TR29 may be connected to the second node QB1.

The second driving part DVP2 may supply a high-level voltage to the third node CQ2 when the (i−1)-th initialization carry signal CR_SS[i−1] is input from the first initialization carry input terminal CRIN2_1. The second driving part DVP2 may include the 22nd to 25th transistors TR22 to TR25.

The second transistor TR22 may be connected between the first initialization carry input terminal CRIN2_1 and a seventh node N7. A gate electrode of the second transistor TR22 may be connected to the first initialization carry input terminal CRIN2_1. The second transistor TR22 may be diode-connected to allow current to flow from the first initialization carry input terminal CRIN2_1 to the seventh node N7.

The third transistor TR23 may be connected between the seventh node N7 and the third node CQ2. A gate electrode of the third transistor TR23 may be connected to the first initialization carry input terminal CRIN2_1.

The 24th transistor TR24 may be connected between the third node CQ2 and the seventh node N7. A gate electrode of the 24th transistor TR24 may be connected to the fourth node QB2.

The 25th transistor TR25 may be connected between the seventh node N7 and the third power input terminal VIN3. A gate electrode of the 25th transistor TR25 may be connected to the fourth node QB2.

The third driving part DVP3 may control a voltage of the first node CQ1 based on the (i+1)-th scan carry signal CR_SC[i+1] input to the second scan carry input terminal CRIN1_2. The third driving part DVP3 may include 20th and 21st transistors TR20 and TR21.

The 20th transistor TR20 may be connected between the first node CQ1 and the eighth node N8. A gate electrode of the 20th transistor TR20 may be connected to the second scan carry input terminal CRIN1_2.

The 21st transistor TR21 may be connected between the eighth node N8 and the third power input terminal VIN3. A gate electrode of the 21st transistor TR21 may be connected to the second scan carry input terminal CRIN1_2.

The fourth driving part DVP4 may control a voltage of the third node CQ2 based on the (i+1)-th initialization carry signal CR_SS[i+1] input to the second initialization carry input terminal CRIN2_2. The fourth driving part DVP4 may include the 18th and 19th transistors TR18 and TR19.

The 18th transistor TR18 may be connected between the third node CQ2 and the seventh node N7. A gate electrode of the 18th transistor TR18 may be connected to the second initialization carry input terminal CRIN2_2.

The 19th transistor TR19 may be connected between the seventh node N7 and the third power input terminal VIN3. A gate electrode of the 19th transistor TR19 may be connected to the second initialization carry input terminal CRIN2_2.

The first reset control part RST1 may control a voltage of the first node CQ1 based on a scan reset signal RST_SC input to the scan reset input terminal SCRST. The first reset control part RST1 may include 16th and 17th transistors TR16 and TR17.

The sixteenth transistor TR16 may be connected between the first node CQ1 and the eighth node N8. A gate electrode of the 16th transistor TR16 may be connected to the scan reset input terminal SCRST.

The 17th transistor TR17 may be connected between the eighth node N8 and the third power input terminal VIN3. A gate electrode of the 17th transistor TR17 may be connected to the scan reset input terminal SCRST.

When the scan reset signal RST_SC is input, the 16th and 17th transistors TR16 and TR17 may be turned on to supply voltage from the third power VGL1 to the first node CQ1. The scan reset signal RST_SC is a signal for initializing a scan stage circuit and may be supplied after a display device is turned on.

The second reset control part RST2 may control a voltage of the third node CQ2 based on the initialization reset signal RST_SS input to the initialization reset input terminal SSRST. The second reset control part RST2 may include 14th and 15th transistors TR14 and TR15.

The 14th transistor TR14 may be connected between the third node CQ2 and the seventh node N7. A gate electrode of the 14th transistor TR14 may be connected to the initialization reset input terminal SSRST.

The fifteenth transistor TR15 may be connected between the seventh node N7 and the third power input terminal VIN3. A gate electrode of the fifteenth transistor TR15 may be connected to the initialization reset input terminal SSRST.

When the initialization reset signal RST_SS is input, the 14th and 15th transistors TR14 and TR15 may be turned on to supply voltage from the third power VGL1 to the third node CQ2. The initialization reset signal RST_SS is a signal for initializing the scan stage circuit and may be supplied after the display device is turned on.

The initialization control part ICP may supply scan signals to the scan lines and initialization signals to the initialization lines based on a sampling signal SAM_S input to the sampling input terminal SAMIN and an initialization control signal INTC input to the initialization terminal INTIN. The initialization control part ICP may include first to thirteenth transistors TR1 to TR13.

The third and fourth transistors TR3 and TR4 may be connected in series between a first sub-node BCR1 and a fifth node N5. Gate electrodes of the third and fourth transistors TR3 and TR4 may be connected to the sampling input terminal SAMIN.

The fifth transistor TR5 may be connected between a sixth node N6 and the first node CQ1. A gate electrode of the fifth transistor TR5 may be connected to the initialization terminal INTIN.

The sixth and seventh transistors TR6 and TR7 may be connected between the first power input terminal VIN1 and the seventh node N7. Gate electrodes of the sixth and seventh transistors TR6 and TR7 may be connected to the third node CQ2.

The eighth and ninth transistors TR8 and TR9 may be connected between the first power input terminal VIN1 and the eighth node N8. Gate electrodes of the eighth and ninth transistors TR8 and TR9 may be connected to the first node CQ1.

The tenth and eleventh transistors TR10 and TR11 may be connected between the fourth node QB2 and the third power input terminal VIN3. A gate electrode of the tenth transistor TR10 may be connected to the fifth node N5, and a gate electrode of the eleventh transistor TR11 may be connected to a gate electrode of the second transistor TR2.

The twelfth and thirteenth transistors TR12 and TR13 may be connected between the first node QB1 and the third power input terminal VIN3. A gate electrode of the twelfth transistor TR12 may be connected to the fifth node N5, and a gate electrode of the thirteenth transistor TR13 may be connected to the sampling input terminal SAMIN.

A first electrode of the first transistor TR1 may be connected to the first power input terminal VIN1, and a second electrode may be connected to the first and second control parts 220 and 320. For example, the second electrode of the first transistor TR1 may be connected to a fourth control transistor MC4 in FIG. 9 and an eighth control transistor MC8 in FIG. 11. A gate electrode of the first transistor TR1 may be connected to a second electrode of a holding capacitor C3. The first transistor TR1 may be turned on or turned off in response to a voltage across the holding capacitor C3.

A first electrode of the second transistor TR2 may be connected to the sixth node N6, and a second electrode may be connected to the third node CQ2. A gate electrode of the second transistor TR2 may be connected to the gate electrode of the fifth transistor TR5. Further, the gate electrode of the second transistor TR2 may be connected to an initialization control part ICP (e.g., a gate electrode of the eleventh transistor TR11).

However, FIG. 8 illustrates one example of the driving part 210, and embodiments are not limited thereto. For example, the driving part 210 may be configured with various circuits currently known in the art that may control the first node CQ1, the second node QB1, the third node CQ2, and the fourth node QB2.

FIG. 9 is a circuit diagram illustrating an embodiment of outputting scan signals of FIG. 6.

Referring to FIG. 9, the i-th stage STi may include a scan stage circuit (e.g., SCT1, see FIG. 3). For clarity and simplicity, FIG. 9 illustrates an operation of i-th stage STi (where i is an odd number) as an example, but the remaining stages may operate similarly to the i-th stage STi.

The scan stage circuit may include a first control part 220, a first boosting control part 230, a first carry output part 240, first output parts 251, 252, and 253, first connecting parts 411, 412, and 413, and a first reset part 260.

The first control part 220 may control a voltage of the first control node CQS1 in response to scan carry signals CR_SC[i−1] and CR_SC[i+1] input to the first scan carry input terminal CRIN1_1 and the second scan carry input terminal CRIN1_2. The first control part 220 may control the voltage of the first control node CQS1 in response to an initialization control signal INTC input to the initialization terminal INTIN.

The first control part 220 may include first control transistors MC1a and MC1b, a second control transistor MC2, a third control transistor MC3, and a fourth control transistor MC4.

The first control transistors MC1a and MC1b may be connected in series between the first power input terminal VIN1 and the first control node CQS1, and gate electrodes may be connected to the first scan carry input terminal CRIN1_1. For example, the first control transistors MC1a and MC1b may be turned on in response to the (i−1)-th scan carry signal CR_SC[i−1] of a previous stage to supply a voltage of the first power VGH1 to the first control node CQS1.

The second control transistor MC2 may be connected between the second power input terminal VIN2 and the first control node CQS1, and a gate electrode may be connected to the first sub-node BCR1. For example, the second control transistor MC2 may be turned on in response to a voltage at the first sub-node BCR1 to supply a voltage of the second power VGH2 to the first control node CQS1.

The third control transistor MC3 may be connected between the second power input terminal VIN2 and the first control node CQS1, and a gate electrode may be connected to the second scan carry input terminal CRIN1_2. For example, the third control transistor MC3 may be turned on in response to the (i+1)-th scan carry signal CR_SC[i+1] of a next stage to supply the voltage of the second power VGH2 to the first control node CQS1.

The fourth control transistor MC4 may be connected between the sixth node N6 and the first control node CQS1 shown in FIG. 8, and a gate electrode may be connected to the initialization terminal INTIN. For example, the fourth control transistor MC4 may be turned on in response to the initialization control signal INTC to electrically connect the sixth node N6 and the first control node CQS1.

The first boosting control part 230 may electrically connect the first sub-node BCR1 to the boosting clock input terminal BIN or the third power input terminal VIN3 in response to voltages of the first node CQ1 and the second node QB1. When the first boosting clock signal BCK1 is supplied to the first sub-node BCR1, it can be described that a first boosting signal is output. The first boosting signal supplied to the first sub-node BCR1 may boost voltages of the first node CQ1 and the second sub-nodes Q1_1, Q1_2, and Q1_3.

The first boosting control part 230 may include a first boosting transistor MB1, a second boosting transistor MB2, and a first capacitor C1.

The first boosting transistor MB1 may be connected between the boosting clock input terminal BIN and the first sub-node BCR1, and a gate electrode may be connected to the first node CQ1. The first boosting transistor MB1 may control an electrical connection between the boosting clock input terminal BIN and the first sub-node BCR1 in response to a voltage of the first node CQ1.

The second boosting transistor MB2 may be connected between the first sub-node BCR1 and the third power input terminal VIN3, and a gate electrode may be connected to the second node QB1. The second boosting transistor MB2 may control an electrical connection between the first sub-node BCR1 and the third power input terminal VIN3 in response to a voltage of the second node QB1.

The first carry output part 240 may electrically connect the first carry output terminal COUT1 to the scan carry clock input terminal CRKIN1 or the third power input terminal VIN3 in response to voltages of the first node CQ1 and the second node QB1. When the first scan carry clock signal SC_CRK1 is output to the first carry output terminal COUT1, it can be described that a scan carry signal (e.g., a first scan carry signal) is output.

The first carry output part 240 may include a first carry transistor MA1 and a second carry transistor MA2.

The first carry transistor MA1 may be connected between the scan carry clock input terminal CRKIN1 and the first carry output terminal COUT1, and a gate electrode may be connected to the first node CQ1. The first carry transistor MA1 may control an electrical connection between the scan carry clock input terminal CRKIN1 and the first carry output terminal COUT1 in response to a voltage of the first node CQ1.

The second carry transistor MA2 may be connected between the first carry output terminal COUT1 and the third power input terminal VIN3, and a gate electrode may be connected to the second node QB1. The second carry transistor MA2 may control an electrical connection between the first carry output terminal COUT1 and the third power input terminal VIN3 in response to a voltage of the second node QB1.

The first output parts 251, 252, and 253 may be connected to any one of the scan clock input terminals SCIN1 to SCIN3, any one of the first output terminals OUT1_1 to OUT1_3, and the fourth power input terminal VIN4, respectively. When the scan clock signals SCK1 to SCK3 are output to the first output terminals OUT1_1 to OUT1_3, it can be described that a scan signal is output.

The 1_1-th output part 251 may include a first output transistor MO1 and a second output transistor MO2.

A gate electrode of the first output transistor MO1 may be connected to a 2_1-th sub-node Q1_1. A gate electrode of the second output transistor MO2 may be electrically connected to the second node QB1. For example, the 1_1-th output part 251 may electrically connect the 1_1-th output terminal OUT1_1 to the first scan clock input terminal SCIN1 or the fourth power input terminal VIN4 in response to voltages of the 2_1-th sub-node Q1_1 and the second node QB1.

The first output transistor MO1 may be connected between the first scan clock input terminal SCIN1 and the 1_1-th output terminal OUT1_1. A gate electrode of the first output transistor MO1 may be connected to the 1_1-th connecting part 411 via the 2_1-th sub-node Q1_1. The first output transistor MO1 may control an electrical connection between the first scan clock input terminal SCIN1 and the 1_1-th output terminal OUT1_1 in response to a voltage on the 2_1-th sub-node Q1_1.

The second output transistor MO2 may be connected between the 1_1-th output terminal OUT1_1 and the fourth power input terminal VIN4, and a gate electrode may be connected to the second node QB1. The second output transistor MO2 may control an electrical connection between the 1_1-th output terminal OUT1_1 and the fourth power input terminal VIN4 in response to a voltage of the second node QB1.

Each of the 1_2-th and 1_3-th output parts 252 and 253 may be configured similarly to the 1_1-th output part 251. Duplicate descriptions are omitted.

The first connecting parts 411, 412, and 413 may be connected between the first node CQ1 and any one of the second sub-nodes Q1_1, Q1_2, and Q1_3, respectively. The first connecting parts 411, 412, and 413 may control an electrical connection between the first node CQ1 and the second sub-nodes Q1_1, Q1_2, and Q1_3 in response to a voltage of the first control node CQS1.

The 1_1-th connecting part 411 may include a first switching transistor MS1 and a first boosting capacitor C2.

The first switching transistor MS1 may be connected between the first node CQ1 and the 2_1-th sub-node Q1_1. A gate electrode of the first switching transistor MS1 may be connected to the first control node CQS1. The first switching transistor MS1 may control an electrical connection between the first node CQ1 and the 2_1-th sub-node Q1_1 in response to a voltage on the first control node CQS1.

The first boosting capacitor C2 may be connected between the 2_1-th sub-node Q1_1 and the first sub-node BCR1. The first boosting capacitor C2 may control a voltage of the 2_1-th sub-node Q1_1 in response to a voltage of the first sub-node BCR1.

For example, when scan signals are output, the first node CQ1 and the 2_1-th sub-node Q1_1 may be electrically blocked by the first switching transistor MS1. Thus, the voltage of the first node CQ1 may be kept constant.

Each of the 1_2-th and 1_3-th connecting parts 412 and 413 may be configured similarly to the 1_1-th connecting part 411. Duplicate descriptions are omitted.

The first reset part 260 may control an electrical connection between the first control node CQS1 and the fifth power input terminal VIN5 in response to a voltage on the second node QB1. The first reset part 260 may reset by discharging the voltage on the first control node CQS1.

The first reset part 260 may include a plurality of reset transistors connected in series between the first control node CQS1 and the fifth power input terminal VIN5.

According to one embodiment, the first reset part 260 may include first reset transistors MR1a and MR1b and a second reset transistor MR2 connected in series between the first control node CQS1 and the fifth power input terminal VIN5. The first reset part 260 may further include third reset transistors MR3a and MR3b connected in parallel with the first reset transistors MR1a and MR1b and the second reset transistor MR2.

The first reset transistors MR1a and MR1b may be connected between the first control node CQS1 and the fifth power input terminal VIN5, and gate electrodes may be connected to the second node QB1. The first reset transistors MR1a and MR1b may control an electrical connection between the first control node CQS1 and the fifth power input terminal VIN5 in response to a voltage on the second node QB1. For example, when the second node QB1 has a high-level voltage, the first reset transistors MR1a and MR1b may be turned on to electrically connect the first control node CQS1 and the fifth power input terminal VIN5.

The second reset transistor MR2 may be connected between the first control node CQS1 and the first reset transistors MR1a and MR1b, and a gate electrode may be connected to the scan carry clock input terminal CRKIN1. The second reset transistor MR2 may control an electrical connection between the first control node CQS1 and the fifth power input terminal VIN5 in response to the first scan carry clock signal SC_CRK1. For example, when the first scan carry clock signal SC_CRK1 is input to the scan carry clock input terminal CRKIN1, the second reset transistor MR2 may electrically disconnect the first control node CQS1 and the fifth power input terminal VIN5 in response to the first scan carry clock signal SC_CRK1.

For example, when the scan carry signals CR_SC[i−1] and CR_SC[i+1] have a high-level voltage and the voltage of the second node QB1 has a high-level voltage, undesired current may flow in a current path IRST_SC between the first control node CQS1 and the fifth power input terminal VIN5. The second reset transistor MR2 may be connected in series with the first reset transistors MR1a and MR1b to block the current path IRST_SC between the first control node CQS1 and the fifth power input terminal VIN5. For example, the second reset transistor MR2 may be turned off in response to the first scan carry clock signal SC_CRK1, thereby blocking the current path IRST_SC between the first control node CQS1 and the fifth power input terminal VIN5. Thus, undesired current may be prevented from flowing in the current path IRST_SC between the first control node CQS1 and the fifth power input terminal VIN5. Thus, unnecessary current losses may be improved.

The third reset transistors MR3a and MR3b may be connected between the first control node CQS1 and the fifth power input terminal VIN5, and gate electrodes may be connected to the scan reset input terminal SCRST. The third reset transistors MR3a and MR3b may control an electrical connection between the first control node CQS1 and the fifth power input terminal VIN5 in response to the scan reset signal RST_SC. For example, when the scan reset signal RST_SC is input to the scan reset input terminal SCRST, the third reset transistors MR3a and MR3b may electrically connect the first control node CQS1 and the fifth power input terminal VIN5 in response to the scan reset signal RST_SC.

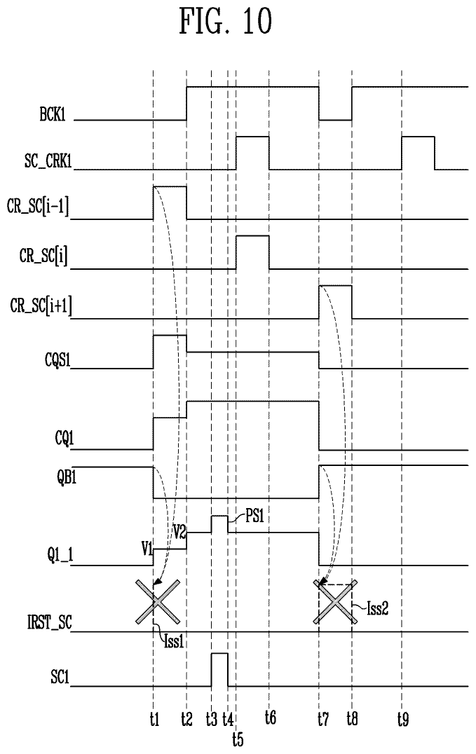

FIG. 10 is a timing diagram illustrating an embodiment of an operation of outputting the scan signals of FIG. 9.

Referring to FIGS. 9 and 10, the first boosting clock signal BCK1, the first scan carry clock signal SC_CRK1, and the scan carry signals CR_SC[i−1], CR_SC[i], and CR_SC[i+1], a voltage of the first control node CQS1, a voltage of the first node CQ1, a voltage of the second node QB1, a voltage of the 2_1-th sub-node Q1_1, a current of the current path IRST_SC, and a first scan signal SC1 are shown. An operation of the i-th stage STi in a display period will be described below. For clarity and simplicity, FIG. 10 illustrates the operation of i-th stage STi (where i is an odd number) as an example, but the remaining stages may operate similarly to the i-th stage STi.

At a first time point t1, the (i−1)-th scan carry signal CR_SC[i−1] input from a previous stage may transition from a low-level voltage to a high-level voltage. In this case, the driving part 402 may supply a voltage of the first power VGH1 to the first node CQ1 and a voltage of the third power VGL1 to the second node QB1. The first control transistors MC1a and MC1b may be turned on in response to the (i−1)-th scan carry signal CR_SC[i−1], and a voltage from the first power VGH1 may be supplied to the first control node CQS1.

The first output transistor MO1 of each of the first output parts 251, 252, and 253 will be turned on in response to the voltage of the first control node CQS1, and the voltage of the first node CQ1 may be transmitted to the 2_1-th sub-node Q1_1. Accordingly, a voltage of the 2_1-th sub-node Q1_1 may transition to a first level voltage V1. FIG. 10 illustrates the 2_1-th sub-node Q1_1 among the second sub-nodes as an example for clarity and simplicity, but the other second sub-nodes may operate similarly to the 2_1-th sub-node Q1_1.

At a second time point t2, the first boosting clock signal BCK1 may transition from a low-level voltage to a high-level voltage. In this case, the first boosting transistor MB1 may be turned on in response to the voltage at the first node CQ1, and the first boosting clock signal BCK1 may be transmitted to the first sub-node BCR1.

A voltage of the first sub-node BCR1 may increase a voltage of the first node CQ1 by the first capacitor C1 connected between the first sub-node BCR1 and the first node CQ1. For example, the voltage of the first node Q1 may be raised to a voltage twice higer than the voltage of the first power VGH1.

The voltage of the first sub-node BCR1 may increase a voltage of the 2_1-th sub-node Q1_1 by the first boosting capacitor C2 connected between the first sub-node BCR1 and the 2_1-th sub-node Q1_1. For example, the voltage of the 2_1-th sub-node Q1_1 may be raised to a voltage twice higer than the voltage of the first power VGH1. Accordingly, at the second time point t2, the voltage of the 2_1-th sub-node Q1_1 may transition from the first level voltage V1 to a second level voltage V2 which is higher.

At the second time point t2, the (i−1)-th scan carry signal CR_SC[i−1] may transition from a high-level voltage to a low-level voltage. In this case, the voltage of the first control node CQS1 may be supplied as the voltage of the second power VGH2 instead of the voltage of the first power VGH1.

The first boosting clock signal BCK1 may have a high-level voltage from the second time point t2 to a seventh time point t7. In this case, in response to the voltage of the first control node CQS1 and the voltage of the first node CQ1, the first output transistor MO1 may remain in a turn-on state. Accordingly, the scan clock signals SCK1 to SCKk (see FIG. 5) may be supplied to the scan lines as scan signals SC1 to SCk. For example, at a third time point t3, the first scan signal SC1 may transition from a low-level voltage to a high-level voltage according to the first scan clock signal SCK1 (see FIG. 5). Then, at a fourth time point t4, the first scan signal SC1 may transition from a high-level voltage to a low-level voltage according to the first scan clock signal SCK1 (see FIG. 5).

A voltage of the first scan signal SC1 may affect the voltage of the 2_1-th sub-node Q1_1. Accordingly, when the first scan signal SC1 has a high-level voltage, a first pulse PS1 may appear at the voltage of the 2_1-th sub-node Q1_1.

At a fifth time point t5, the first scan carry clock signal SC_CRK1 may transition from a low-level voltage to a high-level voltage. The first carry transistor MA1 may be turned on in response to the voltage of the first node CQ1, and the first scan carry clock signal SC_CRK1 may be output as the i-th scan carry signal CR_SC[i]. Accordingly, at a third time point t3, the i-th scan carry signal CR_SC[i] may transition from a low-level voltage to a high-level voltage. The first scan carry clock signal SC_CRK1 may be supplied to a next stage or a previous stage as the i-th scan carry signal CR_SC[i].

At a sixth time point t6, the first scan carry clock signal SC_CRK1 may transition from a high-level voltage to a low-level voltage. Accordingly, at the sixth time point t6, the i-th scan carry signal CR_SC[i] may transition from a high-level voltage to a low-level voltage.

At a seventh time point t7, the first boosting clock signal BCK1 may transition from a high-level voltage to a low-level voltage. The (i+1)-th scan carry signal CR_SC[i+1] input from a next stage may be transitioned from a low-level voltage to a high-level voltage. In this case, the driving part 402 may supply the voltage of the third power VGL1 to the first node CQ1 and the voltage of the second power VGH2 to the second node QB1. The third control transistor MC3 may be turned on in response to the (i+1)-th scan carry signal CR_SC[i+1], and the voltage of the second power VGH2 may be supplied to the first control node CQS1.

The first switching transistor MS1 may be turned on in response to the voltage of the first control node CQS1, and the voltage of the first node CQ1 having the voltage of the third power VGL1 may be transferred to the 2_1-th sub-node Q1_1. Accordingly, at the seventh time point t7, the voltage of the first node CQ1 and the voltage of the 2_1-th sub-node Q1_1 may transition to a low-level voltage.

For example, at the first time point t1, the (i−1)-th scan carry signal CR_SC[i−1] input from the previous stage may transition from a low-level voltage to a high-level voltage, and the voltage of the second node QB1 may transition from a high-level voltage to a low-level voltage. Accordingly, the (i−1)-th scan carry signal CR_SC[i−1] and the voltage of the second node QB1 may simultaneously and temporarily have a high-level voltage. The first scan carry clock signal SC_CRK1 may have a low-level voltage. In this case, one end of the first control node CQS1 may be supplied with a voltage of the first power VGH1 in response to the (i−1)-th scan carry signal CR_SC[i−1], and the other end of the first control node CQS1 may be supplied with a voltage of the fifth power VGL3 in response to the voltage of the second node QB1.

However, the second reset transistor MR2 connected between the first control node CQS1 and the fifth power input terminal VIN5 may be turned off in response to the first scan carry clock signal SC_CRK1, thereby cutting off the voltage of the fifth power VGL3 supplied to the first control node CQS1. Thus, at the first time point t1, an undesired current Iss1 may be prevented from flowing in the current path IRST_SC between the first control node CQS1 and the fifth power input terminal VIN5.

From the seventh time point t7 to an eighth time point t8, the (i+1)-th scan carry signal CR_SC[i+1] input from the next stage may have a high-level voltage. And, from the seventh time point t7 onward, the voltage of the second node QB1 may have a high-level voltage. Accordingly, in an interval from the seventh time point t7 to the eighth time point t8, the (i+1)-th scan carry signal CR_SC[i+1] and the voltage of the second node QB1 may have a high-level voltage at the same time. In the interval from the seventh time point t7 to the eighth time point t8, the first scan carry clock signal SC_CRK1 may have a low-level voltage. In this case, one end of the first control node CQS1 may be supplied with a voltage of the second power VGH2 in response to the (i+1)-th scan carry signal CR_SC[i+1], and the other end of the first control node CQS1 may be supplied with a voltage of the fifth power VGL3 in response to the voltage of the second node QB1.

However, the second reset transistor MR2 connected between the first control node CQS1 and the fifth power input terminal VIN5 may be turned off in response to the first scan carry clock signal SC_CRK1, thereby cutting off the voltage of the fifth power VGL3 supplied to the first control node CQS1. Thus, in the interval from the seventh time point t7 to the eighth time point t8, an undesired current Iss2 may be prevented from flowing in the current path IRST_SC between the first control node CQS1 and the fifth power input terminal VIN5.

As such, the second reset transistor MR2 operating in response to the first scan carry clock signal SC_CRK1 may be connected between the first control node CQS1 and the fifth power input terminal VIN5 to prevent undesired current from flowing into the current path IRST_SC between the first control node CQS1 and the fifth power input terminal VIN5, thereby improving unnecessary current losses.

FIG. 11 is a circuit diagram illustrating an embodiment of outputting initialization signals of FIG. 7.

Referring to FIG. 11, the i-th stage STi may include an initialization stage circuit (e.g., SST1, see FIG. 3). For clarity and simplicity, FIG. 11 illustrates an operation of i-th stage STi (where i is an odd number) as an example, but the remaining stages may operate similarly to the i-th stage STi.

The initialization stage circuit may include a second control part 320, a second boosting control part 330, a second carry output part 340, second output parts 351, 352, and 353, second connecting parts 421, 422, and 423, and a second reset part 360.

The second control part 320 may control a voltage of the second control node CQS2 in response to the initialization carry signals CR_SS[i−1] and CR_SS[i+1] input to the first initialization carry input terminal CRIN2_1 and the second initialization carry input terminal CRIN2_2. The second control part 320 may control a voltage of the second control node CQS2 in response to an initialization control signal INTC input to the initialization terminal INTIN.

The second control part 320 may include fifth control transistors MC5a and MC5b, a sixth control transistor MC6, a seventh control transistor MC7, and an eighth control transistor MC8.

The fifth control transistors MC5a and MC5b may be connected in series between the first power input terminal VIN1 and the second control node CQS2, and gate electrodes may be connected to the first initialization carry input terminal CRIN2_1. For example, the fifth control transistors MC5a and MC5b may be turned on in response to the (i−1)-th initialization carry signal CR_SS[i−1] of a previous stage to supply a voltage of the first power VGH1 to the second control node CQS2.

The sixth control transistor MC6 may be connected between the second power input terminal VIN2 and the second control node CQS2, and a gate electrode may be connected to the third sub-node BCR2. For example, the sixth control transistor MC6 may be turned on in response to a voltage at the third sub-node BCR2 to supply a voltage of the second power VGH2 to the second control node CQS2.

The seventh control transistor MC7 may be connected between the second power input terminal VIN2 and the second control node CQS2, and a gate electrode may be connected to the second initialization carry input terminal CRIN2_2. For example, the seventh control transistor MC7 may be turned on in response to the (i+1)-th initialization carry signal CR_SS[i+1] of a next stage to supply the voltage of the second power VGH2 to the second control node CQS2.

The eighth control transistor MC8 may be connected between the sixth node N6 and the second control node CQS2 shown in FIG. 8, and a gate electrode may be connected to the initialization terminal INTIN. For example, the eighth control transistor MC8 may be turned on in response to the initialization control signal INTC to electrically connect the sixth node N6 and the second control node CQS2.

The second boosting control part 330 may electrically connect the third sub-node BCR2 to the boosting clock input terminal BIN or the third power input terminal VIN3 in response to voltages of the third node CQ2 and the fourth node QB2. When the first boosting clock signal BCK1 is supplied to the third sub-node BCR2, it can be described that the first boosting signal is output. The first boosting signal supplied to the third sub-node BCR2 may boost the voltages of the third node CQ2 and the fourth sub-nodes Q2_1, Q2_2, and Q2_3.

The second boosting control part 330 may include a third boosting transistor MB3, a fourth boosting transistor MB4, and a second capacitor C4.

The third boosting transistor MB3 may be connected between the boosting clock input terminal BIN and the third sub-node BCR2, and a gate electrode may be connected to the third node CQ2. The third boosting transistor MB3 may control an electrical connection between the boosting clock input terminal BIN and the third sub-node BCR2 in response to the voltage of the third node CQ2.

The fourth boosting transistor MB4 may be connected between the third sub-node BCR2 and the third power input terminal VIN3, and a gate electrode may be connected to the fourth node QB2. The fourth boosting transistor MB4 may control an electrical connection between the third sub-node BCR2 and the third power input terminal VIN3 in response to the voltage of the fourth node QB2.

The second carry output part 340 may electrically connect the second carry output terminal COUT2 to the initialization carry clock input terminal CRKIN2 or the third power input terminal VIN3 in response to voltages of the third node CQ2 and the fourth node QB2. When the first initialization carry clock signal SS_CRK1 is output to the second carry output terminal COUT2, it can be described that an initialization carry signal (e.g., an i-th first initialization carry signal) is output.

The second carry output part 340 may include a third carry transistor MA3 and a fourth carry transistor MA4.

The third carry transistor MA3 may be connected between the initialization carry clock input terminal CRKIN2 and the second carry output terminal COUT2, and a gate electrode may be connected to the third node CQ2. The third carry transistor MA3 may control an electrical connection between the initialization carry clock input terminal CRKIN2 and the second carry output terminal COUT2 in response to the voltage of the third node CQ2.

The fourth carry transistor MA4 may be connected between the second carry output terminal COUT1 and the third power input terminal VIN3, and a gate electrode may be connected to the fourth node QB2. The fourth carry transistor MA4 may control an electrical connection between the second carry output terminal COUT2 and the third power input terminal VIN3 in response to the voltage of the fourth node QB2.

The second output parts 351, 352, and 353 may be connected to any one of the initialization clock input terminals SSIN1 to SSIN3, any one of the second output terminals OUT2_1 to OUT2_3, and the fourth power input terminal VIN4, respectively. When the initialization clock signals SSK1 to SSK3 are supplied to the second output terminals OUT2_1 to OUT2_3, it can be described that an initialization signal is output.

The 2_1-th output part 351 may include a third output transistor MO3 and a fourth output transistor MO4.

A gate electrode of the third output transistor MO3 may be connected to the 4_1-th sub-node Q2_1. The gate electrode of the third output transistor MO3 may be electrically connected to the fourth node QB2. For example, the 2_1-th output part 351 may electrically connect the 2_1-th output terminal OUT2_1 to the first initialization clock input terminal SSIN1 or the fourth power input terminal VIN4 in response to the voltages of the 4_1-th sub-node Q2_1 and the fourth node QB2.

The third output transistor MO3 may be connected between the first initialization clock input terminal SSIN1 and the first initialization clock input terminal SSIN1. A gate electrode of the third output transistor MO3 may be connected to the 2_1-th connecting part 421 via the 4_1-th sub-node Q2_1. The third output transistor MO3 may control an electrical connection between the first initialization clock input terminal SSIN1 and the 2_1-th output terminal OUT2_1 in response to the voltage of the 4_1-th sub-node Q2_1.

The fourth output transistor MO4 may be connected between the 2_1-th output terminal OUT2_1 and the fourth power input terminal VIN4, and a gate electrode may be connected to the fourth node QB2. The fourth output transistor MO4 may control an electrical connection between the 2_1-th output terminal OUT2_1 and the fourth power input terminal VIN4 in response to the voltage of the fourth node QB2.

Each of the 2_2-th and 2_3-th output parts 352 and 353 may be configured similarly to the 2_1-th output part 351. Duplicate descriptions are omitted.

The second connecting parts 421, 422, and 423 may be connected between any one of the four sub-nodes Q2_1, Q2_2, and Q2_3 and the third node CQ2, respectively. The second connecting parts 421, 422, and 423 may control an electrical connection between the third node CQ2 and the fourth sub-nodes Q2_1, Q2_2, and Q2_3 in response to a voltage of the second control node CQS2.

The 2_1-th connecting part 421 may include a second switching transistor MS2 and a second boosting capacitor C5.

The second switching transistor MS2 may be connected between the third node CQ2 and the 4_1-th sub-node Q2_1. The gate electrode of the second switching transistor MS2 may be connected to the second control node CQS2. The second switching transistor MS2 may control an electrical connection between the third node CQ2 and the 4_1-th sub-node Q2_1 in response to a voltage of the second control node CQS2.

The second boosting capacitor C5 may be connected between the 4_1-th sub-node Q2_1 and the third sub-node BCR2. The second boosting capacitor C5 may control a voltage of the 4_1-th sub-node Q2_1 in response to the voltage of the third sub-node BCR2.

Each of the 2_2-th and 2_3-th connecting parts 432 and 433 may be configured similarly to the 2_1-th connecting part 431. Duplicate descriptions are omitted.

The third reset part 360 may control an electrical connection between the second control node CQS2 and the fifth power input terminal VIN5 in response to the voltage of the fourth node QB2. The third reset part 360 may reset by discharging the voltage of the second control node CQS2.

The third reset part 360 may include a plurality of reset transistors connected in series between the second control node CQS2 and the fifth power input terminal VIN5.

According to one embodiment, the third reset part 360 may include fourth reset transistors MR4a and MR4b and a fifth reset transistor MR5 connected in series between the second control node CQS2 and the fifth power input terminal VIN5. The third reset part 360 may further include sixth reset transistors MR6a and MR6b connected in parallel with the fourth reset transistors MR4a and MR4b and the fifth reset transistor MR5.

The fourth reset transistors MR4a and MR4b may be connected between the second control node CQS2 and the fifth power input terminal VIN5, and gate electrodes may be connected to the fourth node QB2. The fourth reset transistors MR4a and MR4b may control an electrical connection between the second control node CQS2 and the fifth power input terminal VIN5 in response to a voltage on the fourth node QB2. For example, when the fourth node QB2 has a high-level voltage, the fourth reset transistors MR4a and MR4b may be turned on to electrically connect the second control node CQS2 and the fifth power input terminal VIN5.

The fifth reset transistor MR5 may be connected between the second control node CQS2 and the fourth reset transistors MR4a and MR4b, and a gate electrode may be connected to the initialization carry clock input terminal CRKIN2. The fifth reset transistor MR5 may control an electrical connection between the second control node CQS2 and the fifth power input terminal VIN5 in response to the first initialization carry clock signal SS_CRK1. For example, when the first initialization carry clock signal SS_CRK1 is input to the initialization carry clock input terminal CRKIN2, the fifth reset transistor MR5 may electrically disconnect the second control node CQS2 and the fifth power input terminal VIN5 in response to the first initialization carry clock signal SS_CRK1.

For example, when the initialization carry signals CR_SS[i−1] and CR_SS[i+1] have a high-level voltage and the voltage of the fourth node QB2 has a high-level voltage, undesired current may flow in a current path IRST_SS between the second control node CQS2 and the fifth power input terminal VIN5. The fifth reset transistor MR5 may be connected in series with the fourth reset transistors MR4a and MR4b to block the current path IRST_SS between the second control node CQS2 and the fifth power input terminal VIN5. For example, the fifth reset transistor MR5 may be turned off in response to the first initialization carry clock signal SS_CRK1, thereby blocking the current path IRST_SS between the second control node CQS2 and the fifth power input terminal VIN5. Thus, undesired current may be prevented from flowing in the current path IRST_SS between the second control node CQS2 and the fifth power input terminal VIN5. Thus, unnecessary current losses may be improved.

The sixth reset transistors MR6a and MR6b may be connected between the second control node CQS2 and the fifth power input terminal VIN5, and gate electrodes may be connected to the initialization reset input terminal SSRST. The sixth reset transistors MR6a and MR6b may control an electrical connection between the second control node CQS2 and the fifth power input terminal VIN5 in response to the initialization reset signal RST_SS. For example, when the initialization reset signal RST_SS is input to the initialization reset input terminal SSRST, the sixth reset transistors MR6a and MR6b may electrically connect the second control node CQS2 and the fifth power input terminal VIN5 in response to the initialization reset signal RST_SS.

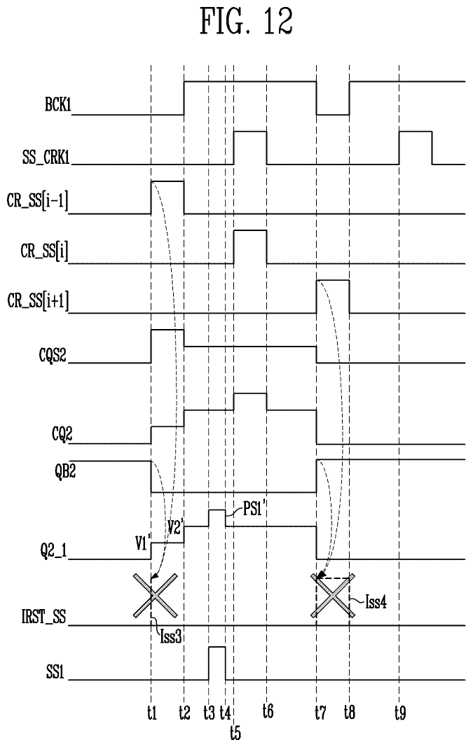

FIG. 12 is a timing diagram illustrating an embodiment of an operation of outputting the initialization signals of FIG. 11.

Referring to FIGS. 11 and 12, the first boosting clock signal BCK1, the first initialization clock signal SS_CRK1, and the initialization carry signals CR_SS[i−1], CR_SS[i], and CR_SS[i+1], a voltage of the second control node CQS2, a voltage of the third node CQ2, a voltage of the fourth node QB2, a voltage of the 4_1-th sub-node Q2_1, a current of the current path IRST_SS, and a first initialization signal SS1 are shown. The operation of the i-th stage STi in a display period is described below. For clarity and simplicity, FIG. 12 illustrates the operation of i-th stage STi (where i is an odd number) as an example, but the remaining stages may operate similarly to the i-th stage STi.

At a first time point t1, the (i−1)-th initialization carry signal CR_SS[i−1] input from a previous stage may transition from a low-level voltage to a high-level voltage. In this case, the driving part 402 may supply the voltage of the first power VGH1 to the third node CQ2 and the voltage of the third power VGL1 to the fourth node QB2. The fifth control transistors MC5a and MC5b may be turned on in response to the (i−1)-th initialization carry signal CR_SS[i−1], and the voltage of the first power VGH1 may be supplied to the second control node CQS2.

The third output transistor MO3 of each of the second output parts 351, 352, and 353 may be turned on in response to the voltage of the second control node CQS2, and the voltage of the third node CQ2 may be transmitted to the 4_1-th sub-node Q2_1. Accordingly, the voltage of the 4_1-th sub-node Q5_1 may transition to the first level voltage V1′. FIG. 12 illustrates the 4_1-th sub-node Q2_1 among the fourth sub-nodes as an example for clarity and simplicity, but the remaining fourth sub-nodes may also operate similarly to the 4_1-th sub-node Q2_1.

At a second time point t2, the first boosting clock signal BCK1 may transition from a low-level voltage to a high-level voltage. In this case, the first boosting transistor MB1 may be turned on in response to the voltage at the third node CQ2, and the first boosting clock signal BCK1 may be transmitted to the third sub-node BCR2.

A voltage of the third sub-node BCR2 may increase a voltage of the third node CQ2 by the fourth capacitor C4 connected between the third sub-node BCR2 and the third node CQ2. For example, the voltage of the third node Q2 may be raised to a voltage twice higher than the voltage of the first power VGH1.

The voltage of the third sub-node BCR2 may increase a voltage of the 4_1-th sub-node Q2_1 by the second boosting capacitor C5 connected between the third sub-node BCR2 and the 4_1-th sub-node Q2_1. For example, the voltage of the 4_1-th sub-node Q2_1 may be raised to a voltage twice higer than the voltage of the first power VGH1. Accordingly, at the second time point t2, the voltage of the 4_1-th sub-node Q2_1 may transition from the first level voltage V1′ to a second level voltage V2′ which is higher.

At the second time point t2, the (i−1)-th initialization carry signal CR_SS[i−1] may transition from a high-level voltage to a low-level voltage. In this case, the voltage of the second control node CQS2 may be supplied as the voltage of the second power VGH2 instead of the voltage of the first power VGH1.

The first boosting clock signal BCK1 may have a high-level voltage from the second time point t2 to a seventh time point t7. In this case, in response to the voltage of the second control node CQS2 and the voltage of the third node CQ2, the third output transistor MO3 may remain in a turn-on state. Accordingly, the initialization clock signals SSK1 to SSKk (see FIG. 5) may be supplied to the initialization lines as the initialization signals SS1 to SSk. For example, at a third time point t3, the first initialization signal SS1 may transition from a low-level voltage to a high-level voltage according to the first initialization clock signal SSK1 (see FIG. 5). Then, at a fourth time point t4, the first initialization signal SS1 may transition from a high-level voltage to a low-level voltage according to the first initialization clock signal SSK1 (see FIG. 5).

A voltage of the first initialization signal SS1 may affect the voltage of the 4_1-th sub-node Q2_1. Accordingly, when the first initialization signal SS1 has a high-level voltage, a first pulse PS1′ may appear at the voltage of the 4_1-th sub-node Q2_1.

At a fifth time point t5, the first initialization carry clock signal SS_CRK1 may transition from a low-level voltage to a high-level voltage. The third carry transistor MA3 may be turned on in response to the voltage of the third node CQ2, and the first initialization carry clock signal SS_CRK1 may be output as the first initialization carry signal CR_SS[i]. Accordingly, at a third time point t3, the i-th initialization carry signal CR_SS[i] may transition from a low-level voltage to a high-level voltage. The first initialization carry clock signal SS_CRK1 may be supplied to a next stage or a previous stage as the first initialization carry signal CR_SS[i].

At a sixth time point t6, the first initialization carry clock signal SS_CRK1 may transition from a high-level voltage to a low-level voltage. Accordingly, at the sixth time point t6, the i-th initialization carry signal CR_SS[i] may transition from the high-level voltage to the low-level voltage.

At a seventh time point t7, the first boosting clock signal BCK1 may transition from a high-level voltage to a low-level voltage. The (i+1)-th initialization carry signal CR_SS[i+1] input from the next stage may be transitioned from a low-level voltage to a high-level voltage. In this case, the driving part 402 may supply the voltage of the third power VGL1 to the third node CQ2 and the voltage of the second power VGH2 to the fourth node QB2. The seventh control transistor MC7 may be turned on in response to the (i+1)-th initialization carry signal CR_SS[i+1], and the voltage of the second power VGH2 may be supplied to the second control node CQS2.

The second switching transistor MS2 is turned on in response to the voltage of the second control node CQS2, and the voltage of the third node CQ2 having the voltage of the third power VGL1 may be transferred to the 4_1-th sub-node Q2_1. Accordingly, at the seventh time point t7, the voltage of the third node CQ2 and the voltage of the 4_1-th sub-node Q2_1 may transition to a low-level voltage.

For example, at the first time point t1, the (i−1)-th initialization carry signal CR_SS[i−1] input from the previous stage may transition from a low-level voltage to a high-level voltage, and the voltage of the fourth node QB2 may transition from a high-level voltage to a low-level voltage. Accordingly, the (i−1)-th initialization carry signal CR_SS[i−1] and the voltage of the fourth node QB2 may simultaneously and temporarily have a high-level voltage. The first initialization carry clock signal SS_CRK1 may have a low-level voltage. In this case, one end of the second control node CQS2 may be supplied with a voltage of the first power VGH1 in response to the (i−1)-th initialization carry signal CR_SS[i−1], and the other end of the second control node CQS2 may be supplied with a voltage of the fifth power VGL3 in response to the voltage of the fourth node QB2.

However, the fifth reset transistor MR5 connected between the second control node CQS2 and the fifth power input terminal VIN5 may be turned off in response to the first initialization carry clock signal SS_CRK1, thereby blocking the voltage of the fifth power VGL3 supplied to the second control node CQS2. Thus, at the first time point t1, an undesired current Iss1 may be prevented from flowing in the current path IRST_SS between the second control node CQS2 and the fifth power input terminal VIN5.

From the seventh time point t7 to an eighth time point t8, the (i+1)-th initialization carry signal CR_SS[i+1] input from the next stage may have a high-level voltage. And, from the seventh time point t7 onward, the voltage of the fourth node QB2 may have a high-level voltage. Accordingly, in an interval from the seventh time point t7 to the eighth time point t8, the (i+1)-th initialization carry signal CR_SS[i+1] and the voltage of the fourth node QB2 may have a high-level voltage at the same time. In the interval from the seventh time point t7 to the eighth time point t8, the first initialization carry clock signal SS_CRK1 may have a low-level voltage. In this case, one end of the second control node CQS2 may be supplied with a voltage of the second power VGH2 in response to the (i+1)-th initialization carry signal CR_SS[i+1], and the other end of the second control node CQS2 may be supplied with a voltage of the fifth power VGL3 in response to the voltage of the fourth node QB2.

However, the fifth reset transistor MR5 connected between the second control node CQS2 and the fifth power input terminal VIN5 may be turned off in response to the first initialization carry clock signal SS_CRK1, thereby cutting off the voltage of the fifth power VGL3 supplied to the second control node CQS2. Thus, in the interval from the seventh time point t7 to the eighth time point t8, an undesired current Iss2 may be prevented from flowing in the current path IRST_SS between the second control node CQS2 and the fifth power input terminal VIN5.

As such, by connecting the fifth reset transistor MR5 operating in response to the first initialization carry clock signal SS_CRK1 between the second control node CQS2 and the fifth power input terminal VIN5, undesired current may be prevented from flowing into the current path IRST_SS between the second control node CQS2 and the fifth power input terminal VIN5 to improve unnecessary current losses.

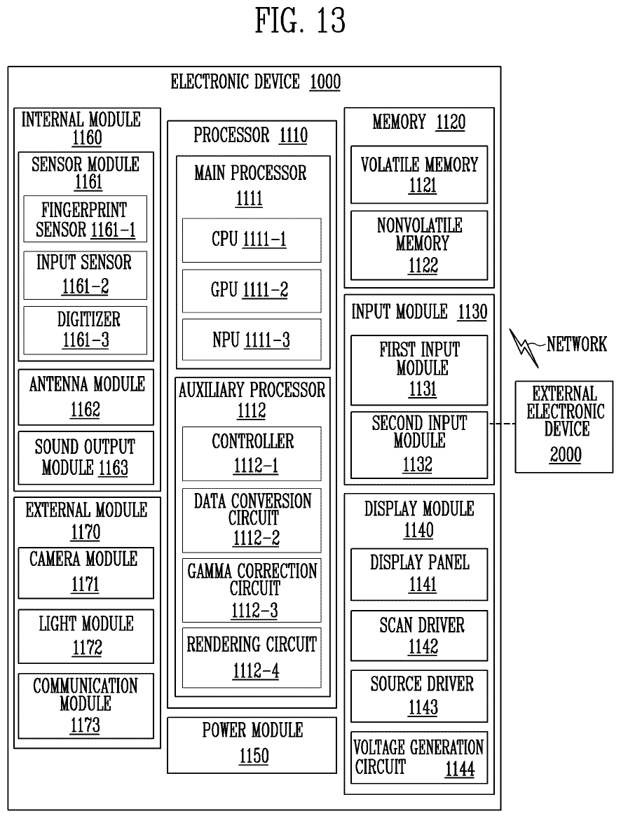

FIG. 13 is a schematic block diagram illustrating an embodiment of an electronic device including a scan driver according to an embodiment of the present disclosure.

Referring to FIG. 13, an electronic device 1000 according to an embodiment of the present disclosure may output various information through a display module 1140. When the processor 1110 executes an application stored in a memory 1120, the display module 1140 may provide application information to a user through a display panel 1141.

A processor 1110 may obtain an external input through an input module 1130 or a sensor module 1161, and may execute an application corresponding to the external input. For example, when the user selects a camera icon (or a camera application icon) displayed on the display panel 1141, the processor 1110 obtains a user input through an input sensor 1161-2 and activates a camera module 1171. The processor 1110 may transmit image data corresponding to a captured image acquired through the camera module 1171 to the display module 1140. The display module 1140 may display an image corresponding to the captured image through the display panel 1141.

For another example, when personal information authentication is executed in the display module 1140, a fingerprint sensor 1161-1 may acquire input fingerprint information as input data. The processor 1110 may compare the input data acquired through the fingerprint sensor 1161-1 with authentication data stored in the memory 1120, and may execute an application according to a comparison result. The display module 1140 may display information executed according to a logic of the application through the display panel 1141. The fingerprint sensor 1161-1 may be arranged to acquire fingerprint information in the entire area of the display module 1140 (or the display panel 1141).

For another example, when a music streaming icon displayed on the display module 1140 is selected, the processor 1110 may obtain the user input through the input sensor 1161-2 and may activate a music streaming application stored in the memory 1120. When a music execution command is input in the music streaming application, the processor 1110 may activate a sound output module 1163 to provide sound information corresponding to the music execution command to the user.

In the foregoing, the operation of the electronic device 1000 has been briefly described. Hereinafter, a configuration of the electronic device 1000 will be described in detail. Some of the components of the electronic device 1000 to be described later may be integrated and provided as one component, and one component may be provided separately as two or more components.

The electronic device 1000 may communicate with an external electronic device 2000 through a network (e.g., a near field communication network or a far field communication network). According to an embodiment, the electronic device 1000 may include the processor 1110, the memory 1120, the input module 1130, the display module 1140, a power module 1150, an internal module 1160, and an external module 1170. According to an embodiment, in the electronic device 1000, at least one of the above-described components may be omitted, or one or more other components may be added. According to an embodiment, some of the above-described components (e.g., the sensor module 1161, an antenna module 1162, or the sound output module 1163) may be integrated into another component (e.g., the display module 1140).

The processor 1110 may execute software to control at least one other component (e.g., a hardware or software component) of the electronic device 1000 coupled to the processor 1110, and may perform various data processing or computations. According to an embodiment, as at least part of data processing or computation, the processor 1110 may store instructions or data received from other components (e.g., the input module 1130, the sensor module 1161, or a communication module 1173) in a volatile memory 1121, process the instructions or the data stored in the volatile memory 1211, and store result data in the non-volatile memory 1122.

The processor 1110 may include a main processor 1111 and an auxiliary processor 1112. The main processor 1111 may include at least one among a central processing unit (CPU) 1111-1 or a application processor (AP). The main processor 1111 may further include any one or more of a graphics processing unit 1111-2 (GPU), a communication processor (CP), and an image signal processor (ISP). The main processor 1111 may further include a neural processing unit (NPU) 111-3. The neural network processing unit 1111-3 is a processor specialized in processing an artificial intelligence model, and the artificial intelligence model may be generated through machine learning. The artificial intelligence model may include a plurality of artificial neural network layers. The artificial neural network may be one of a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-networks, or a combination of two or more of the above, but is not limited to the above examples. The artificial intelligence model may include, in addition to or as an alternative to, a software structure in addition to the hardware structure. At least two of the above-described processing units and processors may be implemented in one integrated configuration (e.g., a single chip), or each may be implemented in an independent configuration (e.g., a plurality of chips).

The auxiliary processor 1112 may include a controller 1112-1. The controller 1112-1 may include an interface conversion circuit and a timing control circuit. For example, the controller 1112-1 may include the controller 110 shown in FIG. 1. The controller 1112-1 may receive an image signal from the main processor 1111, may convert a data format of the image signal to conform to an interface specification with the display module 1140, and may output the image data. The controller 1112-1 may output various control signals necessary for driving the display module 1140.

The auxiliary processor 1112 may further include the data conversion circuit 1112-2, the gamma correction circuit 1112-3, the rendering circuit 1112-4, a touch control circuit (not shown), etc. The data conversion circuit 1112-2 may receive the image data from the controller 1112-1, and may compensate the image data so that an image is displayed with a desired luminance according to a characteristic of the electronic device 1000 or a user's setting, or may convert the image data to reduce power consumption or compensate for an afterimage.

The gamma correction circuit 1112-3 may convert the image data, a gamma reference voltage, or the like so that the image displayed on the electronic device 1000 has a desired gamma characteristic. The rendering circuit 1112-4 may receive the image data from the controller 1112-1 and render the image data in consideration of a pixel arrangement of the display panel 1141 applied to the electronic device 1000.

The touch control circuit may supply a touch signal to the input sensor 1161-2 and receive a sensing signal from the input sensor 1161-2 in response to the touch signal.

At least one among the data conversion circuit 1112-2, the gamma correction circuit 1112-3, the rendering circuit 1112-4, and the touch control circuit 1112-5 may be integrated into another component (e.g., the main processor 1111 or the controller 1112-1). At least one among the data conversion circuit 1112-2, the gamma correction circuit 1112-3, and the rendering circuit 1112-4 may be integrated into a source driver 1143 described below.

The memory 1120 may store various data used by at least one component of the electronic device 1000 (e.g., the processor 1110 or the sensor module 1161) and input data or output data for instructions related to the various data. Various setting data corresponding to a user's setting may be stored in the memory 1120. The memory 1120 may include at least one among a volatile memory 1121 and a non-volatile memory 1122.

The input module 1130 may receive commands or data to be used for components of the electronic device 1000 (e.g., the processor 1110, the sensor module 1161, or the sound output module 1163) from outside the electronic device 1000, such as the user or the external electronic device 2000.

The input module 1130 may include a first input module 1131 to which a command or data is input from the user, and a second input module 1132 to which the command or the data is input from the external electronic device 2000. The first input module 1131 may include a microphone, a mouse, a keyboard, a key (e.g., a button), or a pen (e.g., a passive pen or an active pen). The second input module 1132 may support a designated protocol that can be connected to the external electronic device 2000 by wire or wirelessly. According to an embodiment, the second input module 1132 may include a high-definition multimedia interface (HDMI), a universal serial bus (USB) interface, an SD card interface, or an audio interface. The second input module 1132 may include a connector that can be physically connected to the external electronic device 2000, for example, an HDMI connector, a USB connector, an SD card connector, or an audio connector (e.g., a headphone connector).

The display module 1140 may provide information to the user visually. The display module 1140 may include the display panel 1141, a scan driver 1142, and a source driver 1143. The display module 1140 may further include a window, a chassis, and a bracket for protecting the display panel 1141.

The display panel 1141 (or display) may include a liquid crystal display panel, an organic light-emitting display panel, or an inorganic light-emitting display panel, and the type of the display panel 1141 is not particularly limited. The display panel 1141 may be a rigid type or a flexible type that is rollable or foldable. The display module 1140 may further include a supporter, a bracket, or a heat dissipation member that supports the display panel 1141.

The display panel 1141 may receive image data from the auxiliary processor 1112 and may display an image while controlling the amount of current supplied from the first driving power VDD to the second driving power VSS through the pixels PXL in response to the image data. The display panel 1141 may correspond to the display panel DP illustrated in FIG. 1.

The scan driver 1142 may be mounted on the display panel 1141 as a driving chip. The scan driver 1142 may be integrated into the display panel 1141. For example, the scan driver 1142 may include an ASG (Amorphous Silicon TFT Gate driver circuit), an LTPS (Low Temperature Polycrystalline Silicon) TFT gate driver circuit, or an OSG (Oxide Semiconductor TFT Gate driver circuit) internalized in the display panel 1141. The scan driver 1142 may receive a control signal from the controller 1112-1 and may output scan signals to the display panel 1141 in response to the control signal. The scan driver 1142 may include the scan driver 120 shown in FIG. 1.

The display module 1140 may further include a light emitting driver. The light emission driver may output a light emission control signal to the display panel 1141 in response to the control signal received from the controller 1112-1. The light emission driver may be formed to be distinguished from the scan driver 1142 or may be integrated into the scan driver 1142.

The source driver 1143 may receive a control signal from the controller 1112-1, may convert the image data into an analog voltage (e.g., a data signal) in response to the control signal, and then may output the data signal to the display panel 1141. The source driver 1143 may include the data driver 130 shown in FIG. 1.

The source driver 1143 may be integrated into other components (e.g., controller 1112-1). The functions of the interface conversion circuit and the timing control circuit of the controller 1112-1 described above may be integrated into the source driver 1143.

The display module 1140 may further include a voltage generation circuit 1144. The voltage generation circuit 1144 may output various voltages necessary for driving the display panel 1141.

In an embodiment, the source driver 1143 may convert data corresponding to a red (R), a green (G), and a blue (B) included in the image data received from the processor 1110 into a red data signal (or data voltage), a green data signal, and a blue data signal, and provide them to a plurality of pixel columns included in the display panel 1141 during one horizontal period.

The power module 1150 may supply power to the components of the electronic device 1000. The power module 1150 may include a battery that charges a power voltage. The battery may include a non-rechargeable primary battery, a rechargeable secondary battery, or a fuel cell. The power module 1150 may include a power management integrated circuit (PMIC). The PMIC may supply optimized power to each of the above-described module and a module to be described later. The power module 1150 may include a wireless power transmission/reception member electrically connected to the battery. The wireless power transmission/reception member may include a plurality of antenna radiators in the form of coils. The voltage generation circuit 1144 may be integrated with the power module 1150.

The electronic device 1000 may further include the internal module 1160 and the external module 1170. The internal module 1160 may include the sensor module 1161, the antenna module 1162, and the sound output module 1163. The external module 1170 may include a camera module 1171, a light module 1172, and a communication module 1173.

The sensor module 1161 may detect an input by the user's body or an input by a pen among the first input module 1131, and generate an electrical signal or a data value corresponding to the input. The sensor module 1161 may include at least one or more among a fingerprint sensor 1161-1, an input sensor 1161-2, and a digitizer 1161-3.

The fingerprint sensor 1161-1 may generate a data value corresponding to the user's fingerprint. The fingerprint sensor 1161-1 may include either an optical or capacitive fingerprint sensor.

The input sensor 1161-2 may generate a data value corresponding to coordinate information of the input by a user's body or the input by a pen. The input sensor 1161-2 may generate a capacitance change amount by the input as a data value. The input sensor 1161-2 may detect an input by a passive pen or transmit and receive data to and from an active pen.

The input sensor 1161-2 may measure a bio-signal such as blood pressure, moisture, or body fat. For example, when the user contacts a part of the body with the sensor layer or the sensing panel and does not move for a certain period of time, based on a change in an electric field caused by the part of the body, the input sensor 1161-2 may sense the bio-signal and output information desired by the user to the display module 1140.

The digitizer 1161-3 may generate a data value corresponding to coordinate information of the input by the pen. The digitizer 1161-3 may generate an electromagnetic change amount by the input as a data value. The digitizer 1161-3 may sense the input by the passive pen or transmit and receive data to and from the active pen.

At least one among the fingerprint sensor 1161-1, the input sensor 1161-2, and the digitizer 1161-3 may be implemented as a sensor layer formed on the display panel 1141 through a continuous process. At least one among the fingerprint sensor 1161-1, the input sensor 1161-2, and the digitizer 1161-3 may be disposed on an upper side of the display panel 1141, and any one among the fingerprint sensor 1161-1, the input sensor 1161-2, and the digitizer 1161-3, for example, the digitizer 1161-3 may be disposed under the display panel 1141.

At least two or more among the fingerprint sensor 1161-1, the input sensor 1161-2, and the digitizer 1161-3 may be formed to be integrated into one sensing panel through the same process. In the case of being integrated with the sensing panel, the sensing panel may be disposed between the display panel 1141 and a window disposed above the display panel 1141. According to an embodiment, the sensing panel may be disposed on the window, and the position of the sensing panel is not particularly limited.

At least one among the fingerprint sensor 1161-1, the input sensor 1161-2, and the digitizer 1161-3 may be embedded in the display panel 1141. That is, at least one among the fingerprint sensor 1161-1, the input sensor 1161-2, and the digitizer 1161-3 may be simultaneously formed through a process of forming elements (e.g., a light emitting element, a transistor, and the like) included in the display panel 1141.

The sensor module 1161 may generate an electrical signal or a data value corresponding to an internal state or an external state of the electronic device 1000. The sensor module 1161 may further include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 1162 may include one or more antennas for transmitting or receiving a signal or power to or from the outside. According to an embodiment, the communication module 1173 may transmit a signal to or receive a signal from an external electronic device through an antenna suitable for a communication method. The antenna pattern of the antenna module 1162 may be integrated into one configuration of the display module 1140 (e.g., the display panel 1141), the input sensor 1161-2, or the like.

The sound output module 1163 may be a device for outputting a sound signal to the outside of the electronic device 1000, and may include, for example, a speaker used for general purposes such as multimedia playback or recording playback, and a receiver used exclusively for phone reception. According to an embodiment, the receiver may be formed integrally with or separately from the speaker. A sound output pattern of the sound output module 1163 may be integrated with the display module 1140.

The camera module 1171 may capture a still image and a moving image. According to an embodiment, the camera module 1171 may include one or more lenses, an image sensor, or an image signal processor. The camera module 1171 may further include an infrared camera capable of measuring the presence or absence of a user, a position of the user, a gaze of the user, and the like.

The light module 1172 may provide light. The light module 1172 may include a light emitting diode or a xenon lamp. The light module 1172 may operate in conjunction with the camera module 1171 or may operate independently.

The communication module 1173 may support establishment of a wired or wireless communication channel between the electronic device 1000 and the external electronic device 2000, and communication through the established communication channel. The communication module 1173 may include one or both of a wireless communication module such as a cellular communication module, a near field communication module, or a global navigation satellite system (GNSS) communication module and a wired communication module such as a local area network (LAN) communication module or a power line communication module. The communication module 1173 may communicate with the external electronic device 2000 through a near field communication network such as Bluetooth, WiFi direct, or IrDA (infrared data association) or a cellular network, the Internet, or a long-range communication network such as a computer network (e.g., a LAN or a WAN). The various types of communication modules 1173 described above may be implemented as one chip or may be implemented as separate chips.

The input module 1130, the sensor module 1161, the camera module 1171, and the like may be utilized to control the operation of the display module 1140 in conjunction with the processor 1110.

The processor 1110 may output a command or data to the display module 1140, the sound output module 1163, the camera module 1171, or the light module 1172 based on the input data received from the input module 1130. For example, the processor 1110 may generate image data in response to input data applied through a mouse, an active pen, or the like and output the image data to the display module 1140, or may generate command data in response to the input data and output the command data to the camera module 1171 or the light module 1172. In case that input data is not received from the input module 1130, the processor 1110 may switch the operation mode of the electronic device 1000 to a low power mode or a sleep mode to reduce power consumed by the electronic device 1000.

The processor 1110 may output a command or data to the display module 1140, the sound output module 1163, the camera module 1171, or the light module 1172 based on the sensing data received from the sensor module 1161. For example, the processor 1110 may compare the authentication data authorized by the fingerprint sensor 1161-1 with the authentication data stored in the memory 1120, and then execute an application according to the comparison result. The processor 1110 may execute a command or output corresponding image data to the display module 1140 based on the sensing data sensed by the input sensor 1161-2 or the digitizer 1161-3. In case that the sensor module 1161 includes a temperature sensor, the processor 1110 may receive temperature data for a measured temperature from the sensor module 1161, and further perform luminance correction or the like on the image data based on the temperature data.

The processor 1110 may receive measurement data on presence or absence of the user, a position of the user, and a gaze of the user from the camera module 1171. The processor 1110 may further perform luminance correction or the like on the image data based on the measurement data. For example, the processor 1110 that determines the presence or absence of the user through the input from the camera module 1171 may output the image data whose luminance is corrected to the display module 1140 through the data conversion circuit 1112-2 or the gamma correction circuit 1112-3.

Some of the above components may be connected to each other through a communication method between peripheral devices, for example, a bus, a general purpose input/output (GPI), a serial peripheral interface (SPI), a mobile industry processor interface (MIPI), or a Ultra path interconnect (UPI) link to exchange signals (e.g., commands or data) with each other. The processor 1110 may communicate with the display module 1140 through an interface promised to each other, for example, any one of the above-described communication schemes may be used, and is not limited to the communication scheme described above.

While the present disclosure has been described with reference to embodiments thereof, it will be apparent to those of ordinary skill in the art that various changes and modifications may be made thereto without departing from the scope and spirit of the present disclosure as set forth in the following claims.

What is claimed is:

1. A display device comprising:
a display panel including pixels connected to scan lines and initialization lines; and
a scan driver including a plurality of stages configured to output scan signals to the scan lines and configured to output initialization signals to the initialization lines,
wherein a first stage among the plurality of stages includes:
a first control part connected to a first sub-node and configured to control a first control node, wherein a voltage of the first sub-node is controlled by a first node;
first output parts connected to the first node and a second node and configured to output some of the scan signals in response to a voltage of the first control node;
a first carry output part connected to the first node and the second node and configured to output a first carry clock signal to a first carry output terminal in response to a voltage of the first node; and
a first reset part connected between the first control node and a reset power terminal and configured to electrically connect the first control node and the reset power terminal in response to a voltage of the second node, and
wherein the first reset part electrically disconnects the first control node and the reset power terminal in response to the first carry clock signal.

2. The display device of claim 1, wherein the first reset part includes:
first reset transistors connected between the first control node and the reset power terminal, and having a gate electrode connected to the second node; and
a second reset transistor connected between the first control node and the first reset transistors, and having a gate electrode connected to an input terminal of the first carry clock signal.

3. The display device of claim 2, wherein the first reset part is connected to a first power terminal and a second power terminal, and configured to transmit a voltage of the first power terminal to the first control node in response to a first carry signal, and to transmit a voltage of the second power terminal to the first control node in response to a voltage of at least one of a second carry signal and the first sub-node, and
wherein the first carry signal is received from a second stage of the plurality of stages, and the second carry signal is received from a third stage of the plurality of stages.

4. The display device of claim 3, wherein, when the second carry signal has a first voltage level and a voltage of the second node has a second voltage level, the second reset transistor disconnects an electrical connection between the first control node and the reset power terminal in response to the first carry clock signal.

5. The display device of claim 3, wherein, when the first carry signal has a first voltage level and a voltage of the second node has a second voltage level, the second reset transistor disconnects an electrical connection between the first control node and the reset power terminal in response to the first carry clock signal.

6. The display device of claim 3, wherein voltages input to the first and second power terminals are positive voltages, and a voltage input to the reset power terminal is a negative voltage.

7. The display device of claim 3, wherein the first reset part includes:
first control transistors connected between the first power terminal and the first control node, and having a gate electrode connected to an input terminal for the first carry signal;
a second control transistor connected between the second power terminal and the first control node, and having a gate electrode connected to the first sub-node; and
a third control transistor connected between the second power terminal and the first control node, and having a gate electrode connected to an input terminal for the second carry signal.

8. The display device of claim 1, wherein one of the first output parts includes:
a first output transistor connected between an input terminal for one of scan clock signals and an output terminal for one of the scan signals, an having a gate electrode connected to a second sub-node, wherein a voltage of the second sub-node is controlled to be a same voltage as the first sub-node; and
a second output transistor connected between a third power terminal and the output terminal, and having a gate electrode connected to the second node.

9. The display device of claim 8, wherein the first carry output part is configured to output a voltage of the third power terminal to the first carry output terminal in response to a voltage of the second node.

10. The display device of claim 8, wherein the first carry output part includes:
a first carry transistor connected between an input terminal for the first carry clock signal and the first carry output terminal, and having a gate electrode connected to the first node; and
a second carry transistor connected between the third power terminal and the output terminal, and having a gate electrode connected to the second node.

11. The display device of claim 8, wherein the first stage further includes a boosting output part configured to transmit a boosting clock signal to the first sub-node in response to a voltage of the first node and to increase the voltage of the second sub-node according to the first sub-node.

12. The display device of claim 8, wherein the first stage further includes connecting parts configured to electrically connect the first node and the second sub-node in response to the voltage of the first control node.

13. The display device of claim 12, wherein one of the connecting parts includes:
a switching transistor connected between the first node and the second sub-node, and having a gate electrode connected to the first control node; and
a boosting capacitor connected between the first sub-node and the second sub-node.

14. The display device of claim 1, wherein the plurality of stages are configured to output the initialization signals,
wherein the first stage includes:
a second control part connected to a third sub-node and configured to control a second control node, wherein a voltage of the third sub-node is controlled by a third node;
second output parts connected to the third node and a fourth node and configured to output some of the initialization signals in response to a voltage of the second control node;
a second carry output part connected to the third node and the fourth node and configured to output a second carry clock signal to a second carry output terminal in response to a voltage of the third node; and
a second reset part connected between the second control node and the reset power terminal and configured to electrically connect the second control node and the reset power terminal in response to a voltage of the fourth node, and
wherein the second reset part disconnects an electrical connection between the second control node and the reset power terminal in response to the second carry clock signal.

15. The display device of claim 14, wherein the second reset part includes:
third reset transistors connected between the second control node and the reset power terminal, and having a gate electrode connected to the fourth node; and
a fourth reset transistor connected between the second control node and the third reset transistors, and having a gate electrode connected to an input terminal of the second carry clock signal.

16. The display device of claim 14, wherein the first stage further includes a driving part connected to the first control part and the second control part and configured to control voltages of the first to fourth nodes.

17. A scan driver comprising:
a plurality of stages configured to output scan signals,
wherein a first stage among the plurality of stages includes:
a first control part connected to a first sub-node and configured to control a first control node, wherein a voltage of the first sub-node is controlled by a first node;
first output parts connected to the first node and a second node and configured to output some of the scan signals in response to a voltage of the first control node;
a first carry output part connected to the first node and the second node and configured to output a first carry clock signal to a first carry output terminal in response to a voltage of the first node; and
a first reset part connected between the first control node and a reset power terminal and configured to electrically connect the first control node and the reset power terminal in response to a voltage of the second node, and
wherein the first reset part electrically disconnects the first control node and the reset power terminal in response to the first carry clock signal.

18. The scan driver of claim 17, wherein the plurality of stages are configured to output initialization signals,
wherein the first stage includes:
a second control part connected to a third sub-node and configured to control a second control node, wherein a voltage of the third sub-node is controlled by a third node;
second output parts connected to the third node and a fourth node and configured to output some of the initialization signals in response to a voltage of the second control node;
a second carry output part connected to the third node and the fourth node and configured to output a second carry clock signal to a second carry output terminal in response to a voltage of the third node; and
a second reset part connected between the second control node and the reset power terminal and configured to electrically connect the second control node and the reset power terminal in response to a voltage of the fourth node, and
wherein the second reset part disconnects an electrical connection between the second control node and the reset power terminal in response to the second carry clock signal.

19. An electronic device comprising:
one or more processors; and
a display device including pixels and configured to display an image by the pixels under control of the one or more processors,
wherein the display device includes:
a display panel including the pixels connected to scan lines and initialization lines; and
a scan driver including a plurality of stages configured to output scan signals to the scan lines and configured to output initialization signals to the initialization lines,
wherein a first stage among the plurality of stages includes:
a first control part connected to a first sub-node and configured to control a first control node, wherein a voltage of the first sub-node is controlled by a first node;
first output parts connected to the first node and a second node and configured to output some of the scan signals in response to a voltage of the first control node;
a first carry output part connected to the first node and the second node and configured to output a first carry clock signal to a first carry output terminal in response to a voltage of the first node; and
a first reset part connected between the first control node and a reset power terminal and configured to electrically connect the first control node and the reset power terminal in response to a voltage of the second node, and
wherein the first reset part electrically disconnects the first control node and the reset power terminal in response to the first carry clock signal.
